(19) United States
(12) Patent Application Publication
(10) Pub. No.: US 2025/0076118 A1
(43) Pub. Date: Mar. 6, 2025

(54) TECHNIQUES FOR CHARACTERIZING LASER SPECTRAL LINEWIDTHS OF SINGLE-FREQUENCY LASERS WITH SIGMOID FUNCTIONS OF OBSERVATION TIME

(71) Applicant: Xiaotian Steve Yao, Las Vegas, NV (US)

(72) Inventor: Xiaotian Steve Yao, Las Vegas, NV (US)

(21) Appl. No.: 18/821,588

(22) Filed: Aug. 30, 2024

Related U.S. Application Data
(60) Provisional application No. 63/579,698, filed on Aug. 30, 2023.

(51) Int. Cl. G01J 3/32; G01J 3/28

(52) U.S. Cl. CPC G01J 3/32; G01J 2003/283

(57) ABSTRACT

The laser linewidth is an important parameter for characterizing the coherence properties of a single-frequency laser. The disclosure of this patent document provides techniques for characterizing laser spectral linewidths of single-frequency lasers in form of analytical formula in connection with the use of one or more Sigmoid functions of observation time by including various physical origins affecting the laser linewidths in addition to the natural linewidth caused by the spontaneous emission or quantum noise that can be described with an analytical expression known as the Schawlow-Townes-Henry formula. The disclosed methods for characterizing the laser linewidth caused by various factors in analytical formula can be advantageously used in various applications including designing an optical interferometer based sensing device using coherent laser light from a single-frequency laser.

### PRIORITY CLAIM AND RELATED PATENT APPLICATION

This patent document claims the priority and benefits of U.S. Patent Application No. 63/579,698 entitled “TECHNIQUES FOR CHARACTERIZING LASER SPECTRAL LINEWIDTHS OF SINGLE-FREQUENCY LASERS WITH SIGMOID FUNCTIONS OF OBSERVATION TIME” filed by Applicant and Inventor Xiaotian Steve Yao on Aug. 30, 2023, the disclosure of which is incorporated by reference as part of the disclosure of this patent document.

### TECHNICAL FIELD

The disclosure of this patent document relates to single-wavelength lasers and, more specifically, techniques for charactering laser spectral linewidths of such lasers for a wide range of applications using single-wavelength lasers.

### BACKGROUND

Single-frequency continuous-wave (CW) lasers are commonly used in a wide range of applications, including, for example, coherent optical communication [1, 2], high-resolution spectroscopy [3, 4], coherent Lidar [5], fiber optic sensing [6-8], optical atomic clocks [9, 10], and gravitational wave detection [11], or laser-guided targeting applications. The spectral linewidth of a single-frequency CW laser is often described by using the full width at half maximum (FWHM) of the laser's power spectral density and is one of the important parameters for characterizing the performance of single-frequency CW lasers. Laser linewidth measurement is a key technology in the field of systems, devices and applications using single-frequency CW lasers.

### SUMMARY

The disclosure of this patent document provides techniques for characterizing laser spectral linewidths of single-frequency lasers in connection with the use of one or more Sigmoid functions of the observation time by including various physical origins affecting the laser linewidths in various applications. Specifically, the disclosure of this patent document provides techniques for characterizing laser spectral linewidths of single-frequency lasers in form of analytical formula in connection with the use of one or more Sigmoid functions of the observation time by including various physical origins affecting the laser linewidths in addition to the natural linewidth caused by the spontaneous emission or quantum noise that can be described with an analytical expression known as the Schawlow-Townes-Henry formula. The disclosed methods can be advantageously used in various applications including designing an optical interferometer-based sensing device using coherent laser light from a single-frequency laser.

In one aspect, the disclosed techniques can be implemented to provide a method for characterizing a laser linewidth of a single-frequency laser in the time domain. This method includes measuring frequency fluctuations of the single-frequency laser; filtering data of the measured frequency fluctuations by using a high pass filter with a cutoff frequency of fc which is related to an observation time Tc in measuring the frequency fluctuations of the single-frequency laser by Tc=1/fc; and obtaining a probability density function (PDF) from the measured frequency fluctuation data. This method additionally includes taking a full width half maximum (FWHM) width of the PDF as the linewidth of the single-frequency laser at the observation time Tc; changing a value of the cutoff frequency of the high pass filter to different cutoff frequency values to obtain different FWHM values of the PDF corresponding to different observation times; and curve-fitting the FWHM values of the PDF at the different observation times to a single Sigmoid function or a sum of two or more Sigmoid functions to obtain an analytic formula that represents laser linewidth characteristics of the single-frequency laser corresponding to different observation times.

In one implementation of the above method, the measuring of the frequency fluctuations of the single-frequency laser is performed by using a sine-cosine optical frequency detection system.

In one implementation of the above method, the sine-cosine optical frequency detection system includes an unbalanced optical interferometer involving a 3×3 coupler, a 2×4 multimode interference (MMI) coupler, or a 90° hybrid coherent receiver.

In one implementation of the above method, the method further includes a step to subtract noise of a measurement system for measuring the frequency fluctuations of the single-frequency laser by measuring the noise of the measurement system after turning off the single-frequency laser, high-pass filtering the data with different cutoff frequencies, obtaining the equivalent linewidths of the system noise at different observation times corresponding to the different cutoff frequencies, and finally subtracting each equivalent system noise linewidth from the corresponding laser linewidth obtained in Claim 1 at each observation time.

In another aspect, the disclosed techniques can be implemented to provide a spectral domain linewidth analysis method for characterizing a laser linewidth of a single-frequency laser. This method includes measuring frequency fluctuations of the single-frequency laser; taking the fast Fourier transform of the measured frequency fluctuations in form of frequency fluctuation data; computing a power spectral density (PSD) from the fast Fourier transform of the frequency fluctuation data; computing the integral of the PSD in a frequency range starting from a lower frequency to a sufficiently high frequency, wherein the lower frequency is one over an observation time; obtaining different integrals of the PSD with different lower frequencies corresponding to different observation times; obtaining the linewidths at the different observation times from the integrals corresponding to different observation times; and curve-fitting the linewidths of the lasers at different observation times to a single Sigmoid function or a sum of two or more Sigmoid functions to obtain an analytic formula that represents linewidth characteristics of the single-frequency laser corresponding to different observation times.

In one implementation of the above method, the measuring of the frequency fluctuations of the single-frequency laser is performed by using a sine-cosine optical frequency detection system.

In one implementation of the above method, the sine-cosine optical frequency detection system includes an unbalanced optical interferometer constructed with a 3×3 coupler, a 2×4 MMI coupler, or a 90° hybrid coherent receiver.

In one implementation of the above method, the integral of the PSD is approximated by using a β-separation line described in FIG. 2.

In yet another aspect, the disclosed techniques can be implemented to provide a method for characterizing a laser linewidth of a single-frequency laser. This method includes processing measurements of frequency fluctuations of a laser frequency of a single-frequency laser performed by both turning on the single-frequency laser and turning off the single-frequency to extract data of the measured frequency fluctuations of the laser frequency over different observation times in time domain and to obtain a system noise contribution to the measurements of frequency fluctuations based on measurements of frequency fluctuations when turning off the single-frequency laser. This method also includes processing the extracted data of the measured frequency fluctuations of the laser frequency over different observation times in time domain, after subtracting the obtained system noise contribution, to generate an analytical formula that includes one or more Sigmoid functions and represents a relationship between an effective laser linewidth of the single-frequency laser as a function of observation time.

In yet another aspect, the disclosed techniques can be implemented to provide a method for designing an optical interferometer based sensing device using coherent laser light from a single-frequency laser. This designing method includes performing measurements on continuous wave laser light at a single laser wavelength from the single-frequency laser to be used in the optical interferometer based sensing device, processing data from the performed measurements to generate an analytical formula that includes one Sigmoid function or a sum of two or more Sigmoid functions to represent a laser spectral linewidth of the single-frequency laser as a function of different observation times, and using the information of the laser linewidth with respect to different observation times from the analytical formula to design detection circuitry of the optical interferometer based sensing device to optimize sensing operations and to reduce sensing noise. In some implementations of this designing method, the detection circuitry of the optical interferometer based sensing device is designed to operate at one or more different observation times within a range within which the linewidth of the laser fluctuates around a constant laser linewidth less than other observation times outside the range.

In yet another aspect, the disclosed techniques can be implemented to provide a method for obtaining information on a laser linewidth of a single-frequency laser. This method includes processing measurements of frequency fluctuations of a laser frequency of a single-frequency laser performed by both turning on the single-frequency laser and turning off the single-frequency laser to extract data of the measured frequency fluctuations of the laser frequency over different observation times in time domain; processing the extracted data of the measured frequency fluctuations of the laser frequency over different observation times in time domain to compute probability density functions of the measured frequency fluctuations of the laser frequency after subtracting a system noise contribution to the measurements of frequency fluctuations from extracted data based on measurements of frequency fluctuations when turning off the single-frequency laser; and fitting an analytical formula that includes one or more Sigmoid functions to the computed probability density functions of the measured frequency fluctuations of the laser frequency over different observation times in time domain, without the system noise contribution, to transform the data-fitted analytical formula to represent a relationship between an effective laser linewidth of the single-frequency laser as a function of observation time.

The above and other aspects, features and the implementations of the disclosed techniques are described in greater detail in the drawings, the description and the claims.

### BRIEF DESCRIPTION OF DRAWINGS

FIG. 1 shows a schematic of an example of a cosine-sine OFD based on a Michelson interferometer with a 3×3 coupler at its input to split the laser beam from a laser under test (LUT) into 3 laser beams

FIG. 2. Comparison of the data processing procedures between the SDLA method (a) and the disclosed TDLA method (b).

FIG. 3. Flowchart for calculating the effective laser linewidth in the experiment. Measurements of the laser output of LUT are conducted when LUT is off and when LUT is on and the data from the measurements is passed through a high-pass filter. A Voigt line shape fitting is performed on the filtered data to separate the Gaussian linewidth and Lorentzian linewidth of the filtered data, and the characteristics of line width is used to reduce or eliminate the influence of system noise.

FIG. 4 shows measurements of (a) Measured frequency jitter Δv(t) of the external cavity laser taken with a sampling rate of 100 Ms/s and an an optical path difference (OPD) of 658 m; (b) the corresponding 3D PDF plot, where color and height represent the amplitude of the PDF. (c) Measured frequency jitter Δv(t) of the grating-stabilized diode laser taken with a sampling rate of 1 Gs/s and an OPD of 23 m; (d) the corresponding 3D PDF plot.

FIG. 5 shows two examples of the probability density function (PDF) measurements of two different lasers with an observation duration Tc of 1 μs (fc=1 MHz).

FIG. 6 shows examples of effective linewidths of lasers as a single Sigmoid function of the observation time.

FIG. 7 shows example measurements for the effective linewidth analysis of a commercial fiber laser by NKT Photonics.

FIG. 8 show examples of measurements of frequency fluctuations Δv(t) of two desk-top tunable lasers measured with an OPD of 658 m. (a) Yenista laser (Model TUNICS-T100SHP); (b) Newport laser (Model TLB-8800-HSH-CL).

FIG. 9 shows the effective linewidths of the Yenista laser (a) and the Newport laser (b) as a function of the observation time (blue circles and brown triangles) obtained with the TDLA procedure described in FIG. 3.

FIG. 10 shows examples of measurements of the laser linewidth of a commercial Yenista laser.

FIG. 11 shows measurements of the power spectral density (PSD) of frequency noise of the commercial Yenista laser and comparison of the linewidths of the Yenista laser obtained with the SDLA and TDLA methods.

FIGS. 12 and 13 show two examples of data fitting of Sigmoid expressions to measured laser linewidths as a function of the observation time.

FIG. 14 shows an example of the system noise equivalent linewidths Δv_{n,V} as a function of the observation time at different sampling rates measured with an OPD of 658 m.

FIG. 15 shows data from 20-time repeatability measurements of the effective linewidth using the OFD of FIG. 1 (OPD=658 m) and the TDLA method.

FIG. 16 shows an example of simulated relative linewidth measurement error (RLWE) as a function of Δvₗ/Δv_{n,V} at different observation times (OPD=658 m). (a) At a sampling rate of 100 Ms/s with Δv_{n,V}=570 Hz. (b) At a sampling rate of 1 Gs/s with Δv_{n,V}=825 Hz.

FIG. 17 shows the measured temperature inside the thermally insulated enclosure containing the interferometer of the OFD system in FIG. 1.

### DETAILED DESCRIPTION

The effective spectral linewidth of the continuous-wave laser light from a single-frequency laser is impacted by various factors, including the properties of the lasing media, the laser cavity and external factors. The effective spectral linewidth can be characterized by the “natural linewidth” caused by the spontaneous emission noise (white noise) and the “technical linewidth” resulting from the flicker noises (pink noise or 1/f noise) due to laser cavity fluctuations of various types [12, 13]. The natural linewidth is the lower limit of the actual laser linewidth and can be expressed by the Schawlow-Townes-Henry (STH) formula [14, 15], while the technical linewidth is considered as the broadening from this lower limit, which generally increases with the measurement or observation time and can be significantly larger than the natural linewidth (e.g., hundreds of times in some circumstances).

In various laser applications, a single-frequency laser emitting continuous-wave laser light at a single frequency can be coupled to a laser feedback control loop to control the laser so as to reduce the “technical linewidth” resulting from the flicker noises (pink noise or 1/f noise) due to laser cavity fluctuations of various types [12, 13] or to reduce the relative intensity noise (RIN). Various feedback control mechanism can be implemented, including, for example, feedback control mechanisms for controlling the laser temperature, the laser cavity length, or the pump energy to stabilize the laser frequency, to reduce the frequency draft, or to reduce the frequency fluctuations or noise. Such a laser feedback control loop may include the single-frequency laser to be controlled, an optical splitter that splits a portion of the laser output light for the feedback loop, and a detection module that detects the split portion of the laser output light to produce a laser error indication signal and a feedback control module that generates a control to the laser based on the laser error indication signal. One example technique for stabilizing the laser frequency is to “lock” the laser frequency to a stable optical frequency reference, such as an optical resonance of an optical resonator or cavity with a high finesse or a narrow resonance known as Pound-Drever-Hall (PDH) technique. Examples of such laser feedback techniques may be found in (1) Handbook of Optics, CHAPTER 27 LASER STABILIZATION by John L. Hall, Matthew S. Taubman, and Jun Ye, JILA University of Colorado and National Institute of Standards and Technology Boulder, Colorado, https://jila.colorado.edu/sites/default/files/2019-09/HdbkOpticsV4_27.pdf; (2) Wikipedia on Pound-Drever-Hall (PDH) technique at https://cn.wikipedia.org/wiki/Pound%E2%80%93Drever%E2%80%93Hall_technique, and (3) C. E. Wieman and L. Hollberg, “Using diode lasers for atomic physics,” Rev. Sci. Instrum. 62, 1 (1991), https://tf.nist.gov/general/pdf/739.pdf.

In coherent communication systems, the natural linewidth determines the coherent property of the single-frequency laser because the flicker noise is negligible over a symbol interval [17] on the order of ns or less. On the other hand, in various laser sensing applications, it is this effective linewidth that determines the actual performance parameters of the systems containing the single-frequency lasers, such as the measurement range, resolution, noise, detection speed, and sensitivity [18-24], because the signal measurement time is on the order of us or more. Therefore, the ability to quickly and accurately determine the effective linewidth of single-frequency lasers at different observation times is of paramount importance for sensor system designs.

Unfortunately, for over 65 years since the publication of the Schawlow-Townes limit for the natural linewidth of a single frequency laser, there have been no widely accepted analytical expressions that can fully characterize the effective linewidth of single-frequency lasers against the observation time, although cumbersome numerical methods are available to calculate the effective linewidth from the measured frequency noise data [25, 26].

Various techniques or schemes have been developed to measure the linewidths of single-frequency lasers [27], including the heterodyne method [28-31] by beating the laser under test (LUT) with a reference laser, the self-heterodyne method by beating the LUT's output with a Brillouin laser pumped by the LUT itself [32], the delayed self-homodyne method by beating the LUT output with its delayed replica [33], and the delayed self-heterodyne method by first frequency-shifting the LUT's output with an acousto-optic modulator (AOM) and then beating it with the non-frequency shifted LUT output going through a long delay [17, 34, 35]. The beat signal in each scheme is then analyzed by an electrical spectrum analyzer (ESP) to obtain the power spectral density (PSD) of the laser light field S_{E}(f), for further linewidth analysis. In order to relax the need of requiring ultra-long optical fiber for providing sufficiently large delay in the self-heterodyne schemes, fiber re-circulating loop methods [36, 37] and PSD envelope fitting methods [38, 39] have also been developed. However, all of these schemes are mostly used for obtaining the natural linewidths of the LUT's, not the effective linewidth containing the contributions of the flicker noise which strongly depend on the measurement time. In fact, the flicker noise contributions to the linewidth measurement are purposely excluded by the Voigt fitting scheme in practice in order to obtain more accurate natural linewidth results [17, 40, 41].

In order to obtain the effective linewidth of a single-frequency laser containing the contributions of the flicker noise, schemes of directly obtaining laser's frequency noise Δv(t) was proposed and implemented [25, 42, 43]. One method of directly obtaining Δv(t) is to use an unbalanced interferometer based on a 3×3 coupler [43, 44]. As an approximation, after the power spectral density S_{Δv}(f) of Δv(t) is calculated, a so called β-separation line is plotted on the S_{Δv}(f) vs. frequency curve to find the intersect points with the PSD curve [25]. The laser's effective linewidth can be obtained by calculating the area of S_{Δv}(f) above the intersect points [42]. In principle, the corresponding observation time may be determined by selecting the lower bound frequency of S_{Δv}(f) data in the integral for calculating the area, although the previous works [25, 42, 43] did not report or mention such a capability.

It is important to mention that various linewidth measurement schemes mentioned above analyze data in the spectral domain, manifested by the needs of processing the data to get either the PSD of the lasers' light field [S_{E}(f)] or the PSD of the lasers' frequency fluctuation [S_{Δv}(f)], which is complex and time consuming because the resolution of the spectrum is limited by the sampling time and multiple averaging is required to obtain the spectral accuracy.

This patent document provides techniques for using analytical functions to characterize the laser spectral linewidth of a single-frequency CW laser to include various factors or processes that impact the actual laser linewidth beyond the natural linewidth representing the contributions of the spontaneous emission or quantum noise. The disclosed techniques provide analytical expressions for characterizing the effective linewidth of a single-frequency laser including the linewidth broadening caused by the flicker noises, which strongly depends on the measurement duration and is much larger than the natural linewidth and thus enable speedy assessment of lasers' coherence properties in various applications. By carefully measuring the instantaneous frequency fluctuations of multiple commercial single-frequency lasers using a specially designed sine-cosine optical frequency analyzer to obtain laser linewidths with a time domain statistical analysis method disclosed herein, the laser linewidths can be expressed as one or more Sigmoid functions of the observation time, which can be validated by well accepted linewidth measurement and analysis results. Such analytical Sigmoid linewidth expression can be used to provide clear linewidth information of the laser and facilitate identifying of the physical origins affecting the laser linewidths. Accordingly, the implementation of such analytical Sigmoid linewidth expression can be used to benefit a large number of applications ranging from coherent distributed sensing to gravitational wave detection.

The disclosed techniques are in part based on measurements of single-frequency lasers. Measurements of the laser frequency fluctuations with time, Δv(t), were conducted by using one of the sine-cosine frequency detection schemes [45-48] with sufficiently high frequency resolution and sufficiently high speed for a sufficiently long period. Instead of the spectral domain analysis, analysis was conducted on the measured laser frequency fluctuations Δv(t) statistically in the time domain, without the need of obtaining the spectral domain power spectral density (PSD) [S_{Δv}(f)]. The laser linewidths corresponding to different measurement durations or observation times T_{ci} can be obtained by calculating the probability distribution function (PDF) of Δv(t) after Δv(t) being filtered by high-pass filters of different cutoff frequencies f_{ci} (T_{ci}=1/f_{ci}, i=1 . . . . N), and then obtaining the width of each PDF by curve fitting to a Voigt function, which can be taken as the linewidth of the laser. With this approach, the laser linewidth as a function of the observation time T_{c} can be quickly obtained.

Measurements of multiple commercially available single-frequency lasers were conducted using the above approach. Based on the measurements, the linewidths of these lasers were fitted as the sum of one or more Sigmoid functions of the observation time, with specific parameters to represent the minimum linewidth (the natural linewidth), the maximum linewidth, and the slope rate of the linewidth change in between. Such analytical representations may be the first time that the laser linewidth as a function of observation time can be fully described by an analytical expression.

A Sigmoid function is a generally S-shaped monotonic function and is used in various applications including, e.g., deep learning architectures as a nonlinear activation function to bind the output between two states, 0 and 1 [49, 50]. In the disclosed techniques for characterizing laser spectral linewidths, the Sigmoid function can be used to represent the laser linewidths between two fixed values, determined by the observation time. The lower limit to the laser spectral linewidth is determined by the white noise dominant at short observation times, while the upper limit to the laser spectral linewidth is determined by the flicker noise dominant at the long observation times. The case of needing more than one Sigmoid functions of observation time to represent the linewidth indicates that an additional process is involved, such as a frequency stabilization or relative intensity noise (RIN) reduction loop in the laser system, to affect the laser's linewidth. Therefore, the Sigmoid presentation of the linewidth can be advantageously used to unveil the noise generation/reduction processes involved inside the laser system.

Conducted measurements and analyses verified that the laser natural linewidths obtained with the disclosed time domain linewidth analysis (TDLA) method follow the well-known laser linewidth caused by the spontaneous emission or quantum noise using the analytical Schawlow-Townes-Henry formula as the laser power is varied. More importantly, the disclosed Sigmoid linewidth analytical expression of the laser linewidth can also be validated by the linewidth values obtained with a commonly-used spectral domain linewidth analysis (SDLA) method, particularly the β-separation line method.

In certain implementations of the disclosed technology, the detection bandwidth of the receiving circuit can be operated with the aid of the Sigmoid expression of the linewidth of the laser used in the system as a function of the observation time. In the region of a constant linewidth at lower observation times in the “S” shaped Sigmoid function, the longer the integration time or the observation time of the circuit (corresponding to narrower receiver bandwidth) is, the better the signal to noise ratio (SNR) of the detection system. However, as the integration time is increased into the linewidth ramping region of the “S” shaped Sigmoid curve leading to wider nearly constant laser linewidths at longer observation times, the SNR may degrade with the increase of the receiver integration time (corresponding to smaller detection bandwidth). Therefore, knowing exactly at what integration time the linewidth starts to increase and the rate of the linewidth increase can help the system designer identify the optimized receiver integration time or bandwidth. It is advantageous to design the detection circuitry of the interferometric sensor system to strategically place the detection bandwidth in the lowland region of the laser based on the Sigmoid formula of the laser linewidth as a function of the observation time and to set the observation or measurement time accordingly to achieve the narrow laser linewidth and an improved SNR. In implementations, the detection circuitry of the optical interferometer based sensing device can be operated at a maximum integration time not to exceed the observation time at which the laser linewidth starts to rapidly ramp up following the Sigmoid function.

### Laser Frequency Noise Measurements and Time Domain Linewidth Analysis

### Sample Optical Frequency Detection System

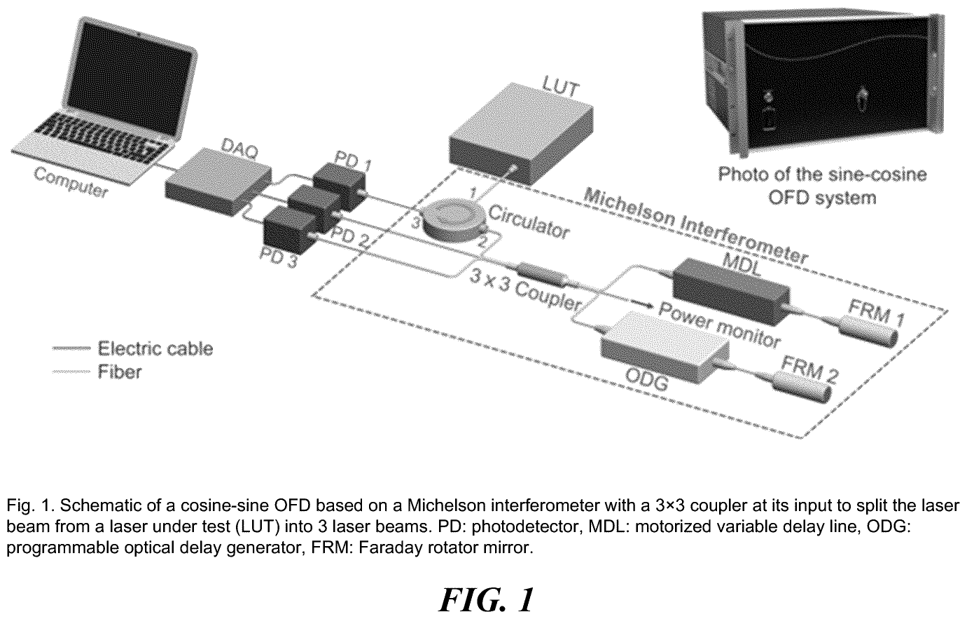

FIG. 1 shows a schematic of an example of a cosine-sine OFD based on a unbalanced Michelson interferometer with a 3×3 coupler at its input to split the laser beam from a laser under test (LUT) into 3 laser beams. PD: photodetector, MDL: motorized variable delay line, ODG: programmable optical delay generator, FRM: Faraday rotator mirror.

This sine-cosine optical frequency detection (OFD) system is based on an unbalanced Michelson interferometer with a 3×3 coupler, as shown in FIG. 1, which is one of the sine-cosine OFD schemes described in [47-48] capable of providing a high frequency resolution and high detection speed. Similar setup was used previously for measuring laser's frequency noises [43]. In FIG. 1, the laser beam from the laser under test (LUT) is first split into three laser beams in three separate optical arms by a 3×3 coupler after passing through a circulator. Two of the three split laser beams are directed to two optical arms of a Michelson interferometer with a 90° faraday mirror at the end of each arm to get rid of polarization fluctuations [51], and the third split laser beam is used for monitoring the optical power of the laser output of the LUT. The two optical arms of this Michelson interferometer are designed to have an optical path difference (OPD). A motorized variable delay line (MDL) is added to one of the Michelson interferometer arms to provide continuous optical path difference (OPD) variations up to 400 mm. A programmable optical delay generator (ODG) [52] is added to the other arm to provide eight different OPDs for the interferometer: 23, 114, 205, 296, 385, 476, 566, and 658 m. The delay in the interferometer determines the frequency measurement resolution and needs to be selected according to the linewidth of the laser being measured. When the LUT laser linewidth is large, a short OPD between the two optical arms of the Michelson interferometer may be used to avoid exceeding the measurement speed limit due to the instantaneous frequency change rate of the laser. When the linewidth is small, a large OPD may be used in the interferometer to obtain a higher system resolution.

The two beams reflected by the Faraday mirrors out of the two optical arms of the Michelson interferometer are directed to overlap at, and thus interfere in, the 3×3 coupler to output three beams, ideally having a phase difference of 120° with one another. The three beams output by the 3×3 coupler are directed into three photodetectors (PD1, PD2, and PD3), respectively, with beam 1 being first routed by the circulator, to convert them into three photovoltages, V₁(t), V₂(t) and V₃(t). The whole interferometer device in FIG. 1 may be carefully insulated thermally in an enclosure with high density polytetrafluoroethylene material, which also serves to damp acoustics and mechanical vibrations.

The system design in FIG. 1 is based on the same or similar design considerations for the sine-cosine optical frequency detection device (OFD) designs for photonics integrated circuits and applications in lidar and other distributed optical sensing in U.S. Pat. No. 11,619,783 B2 by X. S. Yao, entitled Sine-cosine optical frequency detection devices for photonics integrated circuits and applications in lidar and other distributed optical sensing, which is incorporated by reference as part of the disclosure of this patent document. Additional technical information on the sine-cosine optical frequency detection can also be found in an article by X. S. Yao and X. Ma, entitled “Sine-Cosine Techniques for Detecting Fast Optical Frequency Variations with Ultra-High Resolution” as published in Journal of Lightwave Technology 41, 1041-1053 (2023), which is incorporated by reference as part of the disclosure of this patent document. The example system in FIG. 1 uses two Faraday mirrors deployed in the two optical arms of the Michelson interferometer to double the optical path lengths of the two optical arms and use the same 3×3 coupler to generate the input light to the interferometer and to generate the optical interference of the output beams from the two optical arms.

In general, the three photovoltages from the three optical detectors in FIG. 1 can be expressed as [53, 54]

$${V}_{1} ( t ) = {C}_{1} + {B}_{1} cos [ Δθ ( t ) + {β}_{1} ] \qquad ( 1 a )$$

$${V}_{2} ( t ) = {C}_{2} + {B}_{2} cos [ Δθ ( t ) + {β}_{2} ] \qquad ( 1 b )$$

$${V}_{3} ( t ) = {C}_{3} + {B}_{3} cos [ Δθ ( t ) + {β}_{3} ] \qquad ( 1 c )$$

where Cᵢ (i=1, 2, 3) are the offset coefficients, including the contributions from the DC bias of the electronic circuit, Bᵢ are the amplitude coefficients of the measurement system relating to the coupling ratios of the coupler, the responsivity of the photodetectors, and amplification factors of the corresponding circuit, βᵢ (i=1, 2, 3) are the phases of three light beams due to the coupler, and Δθ(t) is the phase change due to the laser frequency variation Av, which relates to the time delay τ of the OPD by:

$$Δ θ ( t ) = 2 π τ Δ v ( t ) \qquad ( 2 )$$

For a perfect 3×3 coupler and ideally balanced photodetectors and associated amplification circuit, Cᵢ=C, Bᵢ=B, β₁=β₀, β₂=β₀−120°, β₃=β₀+120°, Δθ(t) can be expressed as a sine and a cosine function of the three photovoltages, and be further solved unambiguously by taking the ratio of them for a tangent function without phase wrapping issues [47]. It can be shown from Eqs. (1a)-(1c) that even in the non-ideal situations, Δθ(t) can still be solved with a tangent expression:

$$tan Δ θ ( t ) = \frac{\begin{matrix}( \frac{{B}_{3}}{{B}_{1}} cos {β}_{3} - \frac{{C}_{3}}{{C}_{1}} cos {β}_{1} ) * [ {V}_{2} ( t ) - \frac{{C}_{2}}{{C}_{1}} {V}_{1} ( t ) ] - \\ ( \frac{{B}_{2}}{{B}_{1}} cos {β}_{2} - \frac{{C}_{2}}{{C}_{1}} cos {β}_{1} ) * [ {V}_{3} ( t ) - \frac{{C}_{3}}{{C}_{1}} {V}_{1} ( t ) ]\end{matrix}}{\begin{matrix}( \frac{{C}_{2}}{{C}_{1}} sin {β}_{1} - \frac{{B}_{2}}{{B}_{1}} sin {β}_{2} ) * [ {V}_{3} ( t ) - \frac{{C}_{3}}{{C}_{1}} {V}_{1} ( t ) ] - \\ ( \frac{{C}_{3}}{{C}_{1}} sin {β}_{1} - \frac{{B}_{3}}{{B}_{1}} sin {β}_{3} ) * [ {V}_{2} ( t ) - \frac{{C}_{2}}{{C}_{1}} {V}_{1} ( t ) ]\end{matrix}} \qquad ( 3 )$$

The coefficients Cᵢ and Bᵢ, as well as the phase differences (β₂−β₁, β₃−β₁, β₃−β₂) can be obtained by using a tunable laser to scan the laser frequency with a sufficiently large range, getting the three voltages V₁(t), V₂(t) and V₃(t), plotting the Lissajous figures of V₁(t) vs. V₂(t), V₂(t) vs. V₃(t), and V₁(t) vs. V₃(t), and finally performing elliptical fits of the these three Lissajous figures [55]. In the procedure above, β₁ can be assumed to be 0 for simplicity because the three phases are relative. The relative change of the LUT's center frequency Δv(t) can be obtained as:

$$Δ v ( t ) = \frac{1}{2 π τ} Δθ ( t ) \qquad ( 4 )$$

In order to measure lasers with extremely narrow linewidths, the measurement resolution of Δv(t) should be sufficiently fine. For example, for measuring the laser linewidth of 100 Hz, Δv(t) measurement resolution must be much better than 100 Hz. As discussed in [47], with an OPD of 1 km and a digital acquisition card (DAQ) of 15 effective bit resolution, a frequency resolution of 4.6 Hz can be achieved. For our system with a maximum delay of 658 m, a frequency resolution of 7 Hz can be achieved. More detailed discussion on the frequency resolution and other limitations of the sine-cosine OFD can be found in the Supplementary Information Section 1 of this patent document.

### Time Domain Statistical Linewidth Analysis (TDLA)

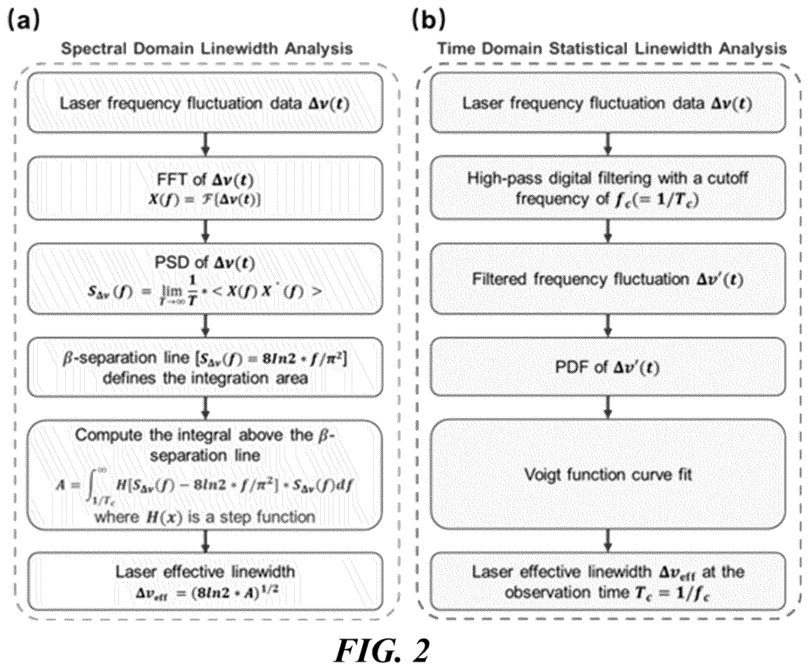

Various other laser linewidth analyses are conducted in the spectral domain as the spectral domain linewidth analysis (SDLA) for verifying the disclosed time domain Time domain Statistical Linewidth Analysis (TDLA). As an example, FIG. 2(a) shows such a SDLA data processing process of using the β-separation line scheme [25, 42, 43] for obtaining the linewidth, in which optical frequency noise data Δv(t) of Eq. (4) is first used to compute S_{Δv}(f), the power spectral density (PSD) of Δv(t). Next, the β-separation line is used to divide S_{Δv}(f) into two areas, one above the line and the other below the line. Finally, the laser line width can then be determined by calculating the area above the β-separation line.

FIG. 2(b) shows an example of processing steps for implementing the techniques disclosed in this patent document by using a Time domain Statistical Linewidth Analysis (TDLA). In particular, the laser frequency noise data Δv(t) is first processed digitally with a high-pass filter (HPF) having a cutoff frequency f_{c} to remove slow frequency variations and obtain filtered frequency noise Δv′ (t), with which the probability density function (PDF) of the frequency noise is computed. Finally, the probability density function (PDF) is curve-fitted to a Voigt function to obtain its −3 dB linewidth. By changing the cutoff frequency f_{c}, the laser linewidth at different observation time T_{c} can be obtained (T_{c}=1/f_{c}). In comparison with the SDLA method, the disclosed TDLA method is more straight forward to implement and faster to compute.

In practice, the measured Δv(t) data contains not only the laser's instantaneous frequency fluctuations responsible for the laser line broadening, but also the noises of the measurement system, including the noises from the PD, the amplifiers and the DAQ card, which are not related to the linewidth and should be excluded from the linewidth calculation.

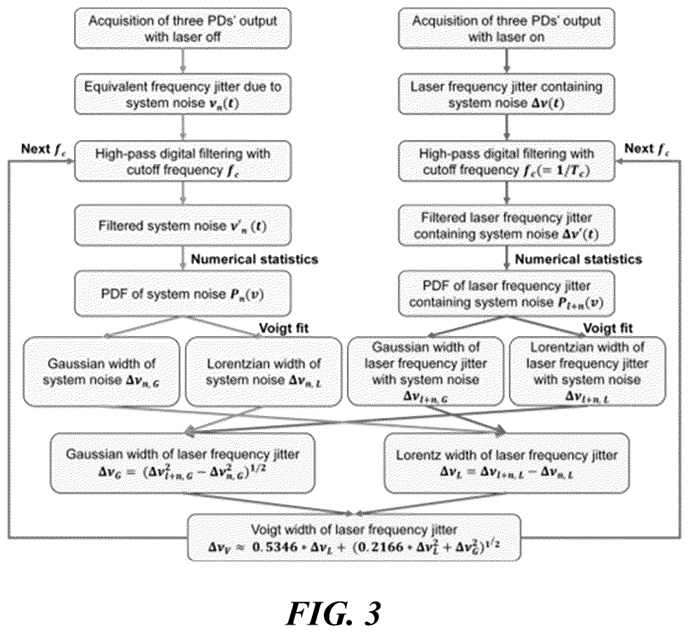

The process of subtracting out the system noise is shown in FIG. 3 based on measured data of a laser under test (LUT). Measurements of the laser output of LUT are conducted when LUT is off and when LUT is on and the data from the measurements is passed through a high-pass filter. A Voigt line shape fitting is performed on the filtered data to separate the Gaussian linewidth and Lorentzian linewidth of the filtered data, and the characteristics of line width is used to reduce or eliminate the influence of system noise.

The system noise can be measured by taking the data of the three voltages V₁ₙ(t), V₂ₙ(t) and V₃ₙ(t) for a period of time when there is no light input and then a computation can be conducted to determine the corresponding equivalent frequency fluctuation Δvₙ(t) using Eqs. (3) and (4). Next, the LUT is turned on to obtain measurement data of the three voltages as V₁′(t), V₂′(t) and V₃′(t) for the same period of time, which can be expressed as

$${V}_{1}^{′} ( t ) = {V}_{1} ( t ) + {V}_{1 n} ( t ) \qquad ( 1 a )$$

$${V}_{2}^{′} ( t ) = {V}_{2} ( t ) + {V}_{2 n} ( t ) \qquad ( 1 b )$$

$${V}_{3}^{′} ( t ) = {V}_{3} ( t ) + {V}_{3 n} ( t ) \qquad ( 1 c )$$

The data set of the three voltages is then used to compute the frequency fluctuation Δv(t) using Eqs. (3) and (4), which includes the contributions of the system noise. After filtering Δv(t) and vₙ(t) with a 3rd-order Butterworth high-pass filter having a cutoff frequency f_{c}, Δv′(t) and Δvₙ′(t) are obtained, which can be used to compute the probability density functions (PDFs) of the combined laser frequency fluctuation and system noise [denoted as Pₗ₊ₙ(v)], and the system noise alone [Pₙ(v)], respectively.

Conducted experiments and measurement data indicate that each of Pₗ₊ₙ(v) and Pₙ(v) can be best fitted with a Voigt function, which is the convolution of Gaussian and Lorentzian line shapes [56]. The resulting FWHM width Δv_{n,V} for Pₙ(v) is called the system noise equivalent linewidth (SNEW). By performing the Voigt fitting and following the procedure in [56], the Gaussian width and Lorentzian width in Pₗ₊ₙ(v) and Pₙ(v) can be separated. Consequently, the contribution of the system noise to the linewidth measurement can be subtracted. Assuming the laser line shape contains both Gaussian and Lorentzian line shape contributions, the corresponding Gaussian linewidth Δv_{G}, the Lorenzian linewidth Δv_{L}, and the final Voigt linewidth Δv_{V} of the laser frequency noise probability density function (PDF) at the full width half maximum (FWHM), excluding the contribution of the system noise, can be obtained as [57]

$$Δ {v}_{G} = \sqrt{Δ {v}_{l + n , G}^{2} - Δ {v}_{n , G}^{2}} \qquad ( 2 a )$$

$$Δ {v}_{L} = Δ {v}_{l + n , L} - Δ {v}_{n , L} \qquad ( 2 b )$$

$$Δ {v}_{V} \approx 0.5346 * Δ {v}_{L} + \sqrt{02166 Δ {v}_{L}^{2} + Δ {v}_{G}^{2}} \qquad ( 2 c )$$

where Δv_{l+n,G} and Δv_{l+n,L} are the Gaussian and Lorentzian linewidths in Pₗ₊ₙ(v), and Δv_{n,G} and Δv_{n,L} are the Gaussian and Lorentzian linewidths in Pₙ(v). This Voigt linewidth is taken as the effective linewidth Δv_{eff} of the LUT.

By changing the cutoff frequency f_{c} of the digital high pass filter, the effective linewidths of the LUT with different observation times T_{c} (T_{c}=1/f_{c}) can be obtained using the same procedure described above, as shown in FIG. 3. Due to the limited processing speed of the computer, a fixed number of data points of 10 million (10M) samples are taken by the data acquisition (DAQ) card and used for the linewidth computation in our measurements. Therefore, the measurement duration and the sampling speed of the DAQ card must be balanced, which can be controlled by the computer in FIG. 1. Higher sampling speed results in shorter measurement duration, and vice versa. For some lasers, two or more sets of data with different sampling rates must be taken and combined to cover the adequate measurement range.

### Conducted Experimental Results

### 3D Presentation of the Frequency Jitter of Two Commercial Lasers

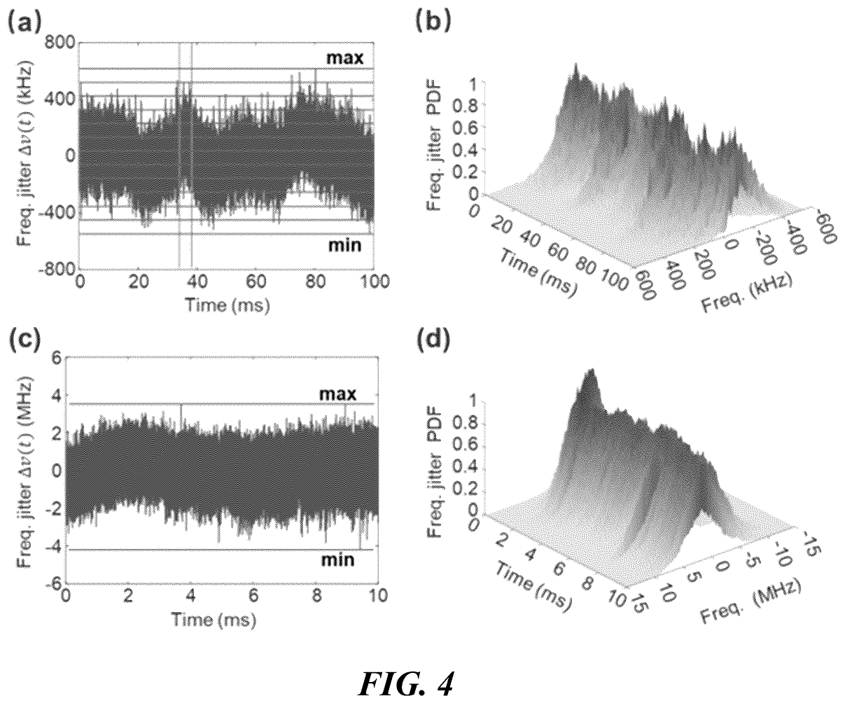

FIG. 4 shows examples of laser measurements: FIG. 4(a) shows measured frequency jitter Δv(t) of the external cavity laser taken with a sampling rate of 100 Ms/s and an OPD of 658 m; FIG. 4(b) shows the corresponding 3D probability density function (PDF) plot, where color and height represent the amplitude of the PDF; FIG. 4(c) shows measured frequency jitter Δv(t) of the grating-stabilized diode laser taken with a sampling rate of 1 Gs/s and an OPD of 23 m; and FIG. 4(d) shows the corresponding 3D PDF plot.

FIG. 4(a) shows the measured frequency jitter Δv(t) of an external cavity laser at 1550 nm (Pure Photonics PPCL550) as a function of time, which is taken with a sampling rate of 100 Ms/s for a duration of 0.1 s and thus contains 10M data points. The delay length in the optical frequency detection (OFD) (FIG. 1) is chosen to be 658 m, corresponding to a frequency measurement resolution of 7 Hz, which is sufficiently smaller than the 10 kHz linewidth specified by the laser manufacturer.

FIG. 4(a) contains the laser frequency fluctuation information, however, it is difficult to visualize how the line shape and linewidth evolve with time. FIG. 4(b) is the three-dimensional (3D) plot of the probability density function (PDF) for the external cavity laser's frequency jitter, which is an intuitive representation of its line shape and linewidth. By first dividing the data along the time axis into Mₜ slices and then along the Δv axis into M_{Δv} slices to form Mₜ×M_{Δv} slots, as shown in FIG. 4(a), the PDF of frequency jitter in each slot can be obtained by taking the ratio of the number of data points in each slot over those in that time slice. In obtaining FIG. 4(b), Mₜ and M_{Δv} are taken to be 200 such that each time slice has a duration of 0.5 ms. Finally, the 3D PDF is obtained by stitching the PDFs of all 200 time slices together.

Similarly, FIG. 4c is the Δv(t) of a grating-stabilized diode laser at 1550 nm (built-in laser in the APEX AP2051A spectrometer) with an output power of 5 dBm, which is obtained with a sampling rate of 1 Gs/s for a duration of 0.01 s and also contains 10M data points, while FIG. 4(d) is the corresponding 3D PDF plot obtained with the same procedure as that of FIG. 4(b). Note that the OPD here is reduced to 23 m to void the frequency variation rate γ exceeding the maximum detection limit γₘₐₓ of the optical frequency detection (OFD) system [47]. In particular, γ obtained by taking the derivative of the data in FIG. 3(c) has a maximum value of 400 THz/s, which exceeded the system limit γₘₐₓ of 228 THz/s for the case of OPD=658 m, as described in the Supplementary Information Section 1 of this patent document. In addition, an OPD of 23 m corresponds to a frequency resolution of 200 Hz [47], still much smaller than the 3 MHz typical laser linewidth specified by the laser manufacturer for valid linewidth measurements.

It can be seen from FIGS. 4(b) and 4(d) that, in addition to the fast frequency fluctuation, each laser's mean frequency also drifts with time. Such drifts contribute to the linewidth broadening with relative long observation durations.

The linewidth property of a laser may vary with the laser operating condition. For example, as the laser is turned on to warm up from cold start, the laser linewidth varies with the laser temperature as observed in conducted experiments. In order to obtain consistent measurement results, the laser should be warmed up for more than 30 minutes before measurements.

### Effective Linewidth of Lasers as a Single Sigmoid Function of Observation Time

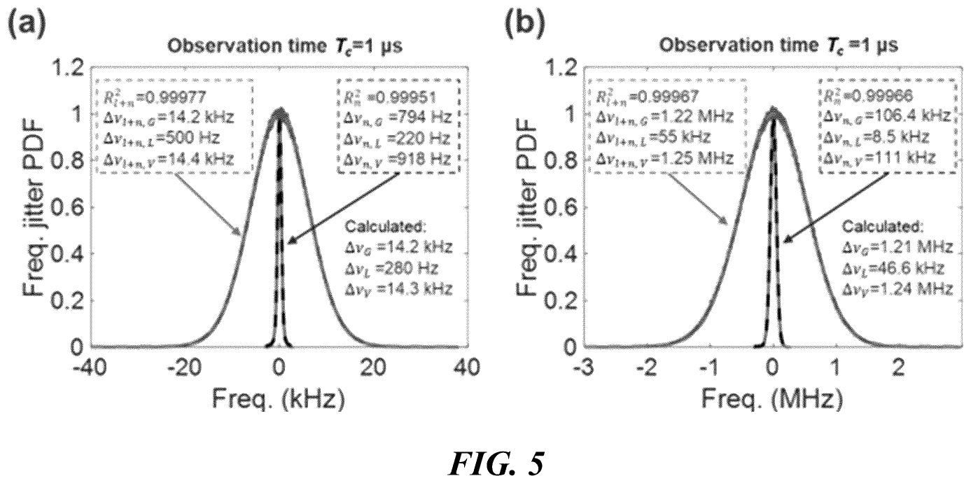

FIG. 5 shows two examples of the probability density function (PDF) measurements of two different lasers with an observation duration Tc of 1 μs (fc=1 MHz): FIG. 5(a) shows the PDF of an external cavity laser measured with a sampling rate of 100 Ms/s and an OPD of 658 m; FIG. 5(b) shows the PDF of a grating-stabilized diode laser measured with a sampling rate of 1 Gs/s and an OPD of 23 m. The blue line represents the PDF of the laser frequency jitter containing system noise, while the dashed red line represents its Voigt curve fit. The green line represents the PDF of the system noise, while the dashed black line represents its Voigt curve fit.

Using the TDLA procedure discussed in FIG. 3, the probability density functions (PDFs) of the frequency variations of the external cavity laser and the grating-stabilized diode laser are obtained and shown with the blue lines in FIGS. 5(a) and 5(b), respectively, in which the cutoff frequency of the high-pass filter is set at 1 MHz, corresponding to an observation duration of 1 μs. In obtaining the PDFs in FIG. 5, the range of laser frequency fluctuation Δv(t) is first divided into 5000 equal slices, similar to that in FIG. 4(a), and the probability of the laser frequency falling in each slice is calculated by taking the ratio of the number of data points in that slice over the total number of data points (10M). A Voigt function is used to fit the PDF of the frequency noise of each laser for separating it into a Gaussian and a Lorentzian line shape with a Gaussian and a Lorentzian linewidth.

In general, the frequency jitter data of FIG. 4(a) contains some system noise, which can be subtracted by applying the procedure in FIG. 3. In particular, by turning the laser off, the probability density function (PDF) of the system noise can also be obtained, as shown by the green line inside the line shape defined by the combined laser frequency and system noises in FIGS. 5(a) and 5(b), which can also be fitted to a Voigt function shown by the black dashed line and be separated into a Gaussian and a Lorentzian line shape with a Gaussian and a Lorentzian linewidth. Finally, they can be separately subtracted from the corresponding Gaussian and Lorentzian linewidths of the PDF of the combined laser frequency and system noises using Eqs. (5a) to (5c).

As shown in FIG. 5(a), with an observation time of 1 μs, the Voigt width and the extracted Gaussian and Lorentzian widths of the external cavity laser's frequency fluctuation are 14.4 kHz, 14.2 kHz, and 500 Hz, respectively, which include contributions from the system noise. For the system noise PDF, the Voigt width and the extracted Gaussian and Lorentzian widths are 918, 794, and 220 Hz, respectively. After subtracting the contributions of system noise, we obtain a Voigt width of 14.3 kHz for the PDF of the external cavity laser's frequency fluctuations at an observation time of 1 μs, which is considered as the effective linewidth of the laser at 1 μs.

Similarly, the PDF of the grating-stabilized diode laser's frequency fluctuation with an observation time of 1 μs is shown in FIG. 5(b). The Voigt, Gaussian, and Lorentzian widths are 1.25, 1.22, and 0.055 MHz, respectively, which include the contributions from the system noise. The corresponding Voigt, Gaussian, and Lorentzian widths of the system noise PDF are 111, 8.5, and 106.4 kHz, respectively, which are insignificant compared with the linewidths of the laser containing the system noise. Consequently, after subtracting the contributions of the system noise using Eq. (5), we obtain the Voigt width of 1.24 MHz, which is taken as the effective linewidth of the grating-stabilized diode lasers at an observation time of 1 μs.

Note that in FIGS. 5(a) and 5(b), the influence of the system noise is quite small and may be effectively ignored. However, in other measurements with lasers of narrow linewidths, the influence of the system noise may be comparatively significant, which necessitates the need for the subtraction of the system noise contribution much larger, which necessitates the need for the subtraction of the system noise contribution. More detailed discussions on this issue can be found in the Supplementary Information of this patent document: Supplementary Information: Limitations and Uncertainties of the Exemplary Optical Frequency Detection (OFD) System with TDLA Approach.

In addition, the system noise equivalent linewidth Δv_{n,V} is inversely proportional to OPD, resulting in Δv_{n,V} in FIG. 4(b) 28.6 times larger than that in FIG. 4(a), which is the ratio of the OPDs used for obtaining the two figures (658 m and 23 m).

In FIGS. 5(a) and (b), the goodness of each Voigt fit to the data is better than 0.999, indicating that the line shape of the laser frequency noise can be well represented by a Voigt function.

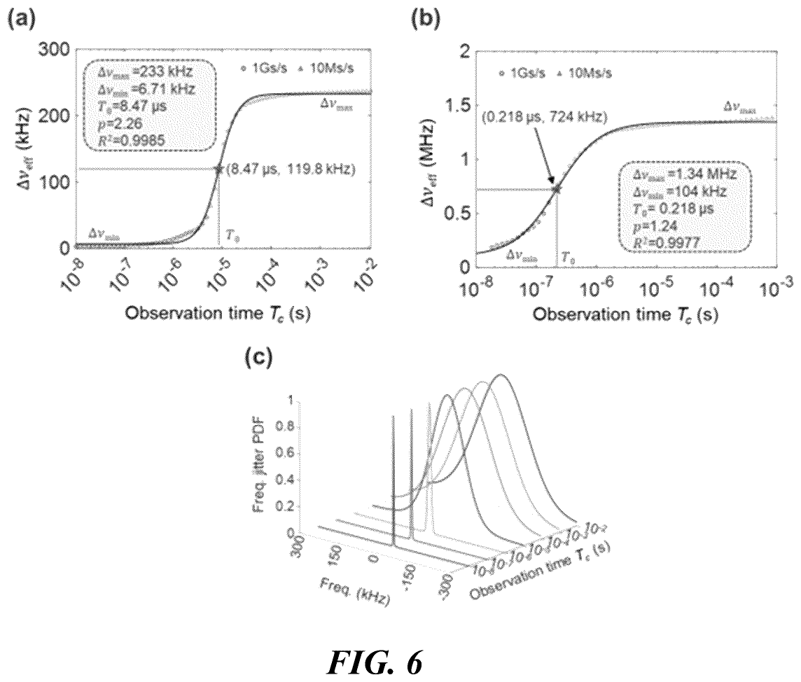

FIG. 6 shows examples of effective linewidths of lasers as a single Sigmoid function of the observation time: FIG. 6(a) shows the laser linewidth of an external cavity laser with logistic function fit (OPD=658 m); FIG. 6(b) shows the laser linewidth of a grating-stabilized diode laser with logistic function fit (OPD=23 m); FIG. 6(c) shows the line shapes as a function of observation time for the external cavity laser. In FIGS. 6(a) and (b), the blue dots and triangles are measured Δv_{eff} at different T_{c}, while the red line in each figure represents the curve-fit to a single logistic function.

By changing the cutoff frequency f_{c} of the high-pass filter, the effective linewidth Δv_{eff} of the external cavity laser at different observation times T_{c}=1/f_{c} can be obtained following the procedure in FIG. 3, with the results shown in FIG. 6. It is interesting to notice from the figure that the change of the effective linewidth Δv_{eff} with T_{c} is “S” shaped, having a “lowland” region with linewidths close to a minimum value Δvₘᵢₙ, a “plateau” region with linewidths close to a maximum value Δvₘₐₓ and a rapid linewidth ramping region between Δvₘᵢₙ and Δvₘₐₓ, which can be fitted to a logistic function, which is a form of the Sigmoid function with the excellent goodness of fit better than 0.997:

$$Δ {v}_{eff} ( {T}_{c} ) = Δ {v}_{max} + \frac{Δ {v}_{min} - Δ {v}_{max}}{1 + {( {T}_{c} / {T}_{0} )}^{p}} \qquad ( 6 a )$$

where T₀ is the observation time corresponding to the average linewidth (Δvₘₐₓ+Δvₘᵢₙ)/2, and p is a parameter for determining the linewidth ramping slope with T_{c}. Note that Δv_{eff} can also be written as a Boltzmann function, a more familiar form of Sigmoid function:

$$Δ {v}_{eff} ( {t}_{c} ) = Δ {v}_{max} + \frac{Δ {v}_{min} - Δ {v}_{max}}{1 + exp [ ( {t}_{c} - {t}_{0} ) / Δ t ]} \qquad ( 6 b )$$

where t_{c}=ln(T_{c}), t₀=ln(T₀), and Δt=1/p. For simplicity, the logistic function Eq. (6a) is selected to represent the effective linewidth Δv_{eff} vs. the observation time T_{c}.

As shown in FIG. 6(a), when the observation time T_{c} decreases from T₀, the effective linewidth Δv_{eff} approaches Δvₘᵢₙ, which can be considered as laser's natural linewidth. As the observation time T_{c} increases from the “lowland”, the effective linewidth Δv_{eff} grows rapidly due to the influence of the 1/f noise before flattening out at Δvₘₐₓ, which in general is dozens of times larger than Δvₘᵢₙ. In order to cover both ends of the observation time T_{c} for getting the complete Sigmoid curve shown in FIG. 6, two sets of data with different sampling rates were combined, one at 10 Ms/s with 1 s duration to cover the “plateau” region and the other at 1 Gs/s with 0.01 s duration to cover the “lowland” region, with each set containing 10M data points.

It is important in practice to determine the range and slope of the rapid linewidth ramping region of a laser. If we define the lower bound of the region T_{low} as 10% of Δvₘₐₓ and the higher bound of the region T_{high} as 90% of Δvₘₐₓ we obtain from Eq. (6a):

$${T}_{low} = {9}^{- 1 / p} \cdot {T}_{0} \qquad ( 7 a )$$

$${T}_{h i g h} = {9}^{1 / p} \cdot {T}_{0} \qquad ( 7 b )$$

The range of the observation time ΔT_{c} with rapid linewidth ramping can be expressed below:

$$Δ {T}_{c} = {T}_{h i g h} - {T}_{low} = ( {9}^{1 / p} - {9}^{- 1 / p} ) \cdot {T}_{0} \qquad ( 7 c )$$

The maximum linewidth ramping slope is at T_{c}=T₀, which can be obtained by taking the derivative of Eq. (6a) and setting it to zero, as

$$R ( {T}_{0} ) = \frac{Δ {v}_{max} - Δ {v}_{min}}{4 {T}_{0}} \cdot p \qquad ( 7 d )$$

For the effective linewidth of the external cavity laser shown in FIG. 6(a), the following parameters can be obtained by fitting the linewidth data at different observation times to the Sigmoid function as: Δvₘᵢₙ=6.7 kHz, Δvₘₐₓ=233 kHz, T₀=8.47 μs, and p=2.26, with Δvₘₐₓ approximately 35 times larger than the natural linewidth Δvₘᵢₙ. From Eqs. (7a-7d), the following parameters can be obtained: T_{low}=3.20 μs, T_{high}=22.39 μs, ΔT_{c}=19.19 μs, and R(T₀)=15.1 kHz/μs. Accordingly, in the region between 3.2 μs and 22.39 μs, the effective linewidth of the laser can be highly sensitive to the observation time, which increases at a rate of 15.1 kHz per μs increment of the observation time.

The effective linewidth of the grating stabilized laser as a function of the observation time in form of a Sigmoid function is shown in FIG. 6(b). Again, it can be perfectly fit to a logistic function, with Δvₘₐₓ=1.34 MHz, Δvₘᵢₙ=104 kHz, T₀=0.218 μs, and p=1.24, with Δvₘₐₓ approximately 13 times larger than the natural linewidth Δvₘᵢₙ. From Eqs. (7a-7d), one further obtains T_{low}=14.3 ns, T_{high}=3.32μ, ΔT_{c}=3.18μ, and R(T₀)=1.76 MHz/μs.

FIG. 6(c) shows the line shapes of the external cavity laser at different observation times. The linewidth evolution with different observation times T_{c} can be clearly visualized.

### Effective Linewidth of a Fiber Laser Expressed as a Double Sigmoid Function of Observation Time

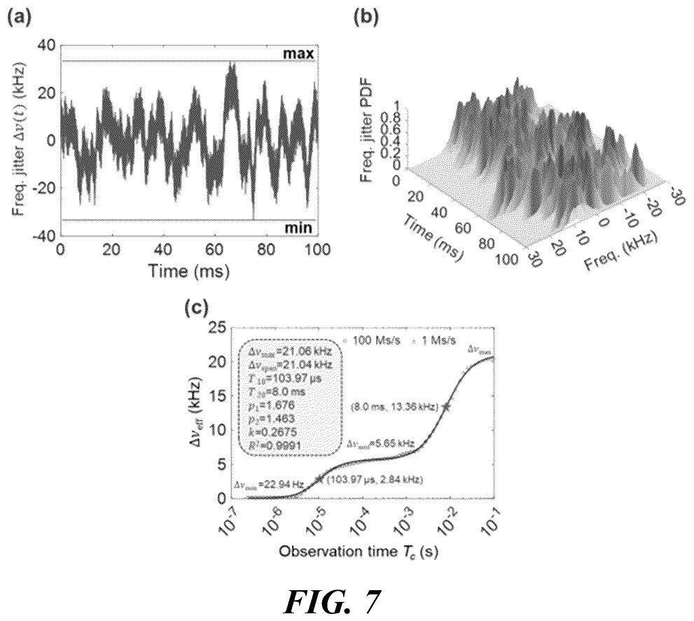

To verify the generality of the Sigmoid function presentation of the linewidth of single-frequency lasers, we measured an ultra-narrow linewidth fiber laser under a model nameKoheras BASIK E15 made by NKT Photonics operating at 1550.12 nm, with an output power of 13 dBm and a specified natural linewidth of 100 Hz. FIG. 7 shows example measurements for the effective linewidth analysis of the NKT fiber laser: FIG. 7(a) shows measured frequency fluctuation data Δv(t) obtained with a sampling rate of 100 Ms/s and an OPD of 658 m; FIG. 7(b) shows a 3D PDF plot of laser frequency fluctuations; and FIG. 7(c) shows effective linewidth data (blue circles and brown triangles) vs. observation time fitted to the superposition of two Sigmoid functions (black line).

FIG. 7(a) shows the measured laser frequency fluctuation data Δv(t) vs. time obtained using the setup of FIG. 1, which were taken with an OPD of 658 m and a sampling rate of 100 Ms/s for a duration of 0.1 s. The laser frequency fluctuation range during this period is +33 kHz.

FIG. 7(b) shows the 3D PDF of the laser frequency jitter, obtained with the same procedure as in FIGS. 4(b) and 4(d).

FIG. 7(c) shows the linewidth vs. observation time T_{c} obtained using the procedure described in FIG. 3. In order to have sufficient range of the observation time T_{c}, two sets of Δv(t) data obtained with sampling rates of 1 Ms/s for a duration of 10 s and 100 Ms/s for a duration of 0.1 s were collected and combined. In processing the data, the cutoff frequencies f_{c} of the high-pass filter were taken from 10 MHz to 10 Hz, corresponding to the observation time from 100 ns to 100 ms.

In this example, the linewidth vs. the observation time can be perfectly fit (with the goodness of fit=0.9991) to the superposition of two Sigmoid functions in the following form:

$$Δ {v}_{eff} ( {T}_{c} ) = Δ {v}_{max} + \frac{Δ {v}_{1 min} - Δ {v}_{1 max}}{1 + {( {T}_{c} / {T}_{10} )}^{{p}_{1}}} + \frac{Δ {v}_{2 min} - Δ {v}_{2 max}}{1 + {( {T}_{c} / {T}_{20} )}^{{p}_{2}}} = Δ {v}_{max} - Δ {v}_{span} [ \frac{k}{1 + {( {T}_{c} / {T}_{10} )}^{{p}_{1}}} + \frac{1 - k}{1 + {( {T}_{c} / {T}_{20} )}^{{p}_{2}}} ] \qquad ( 8 a )$$

where the combined maximum and minimum linewidths from the superposition of two Sigmoid functions are

$$Δ {v}_{max} = Δ {v}_{1 max} + Δ {v}_{2 max} \qquad ( 8 b )$$

$$Δ {v}_{min} = Δ {v}_{1 min} + Δ {v}_{2 min} = Δ {v}_{max} - Δ {v}_{span} \qquad ( 8 c )$$

$$Δ {v}_{span} = Δ {v}_{max} - Δ {v}_{min} \qquad ( 8 d )$$

$$k = \frac{Δ {v}_{1 max} - Δ {v}_{1 min}}{Δ {v}_{span}} = 1 - \frac{Δ {v}_{2 max} - Δ {v}_{2 min}}{Δ {v}_{span}} \qquad ( 8 e )$$

All the parameters in Eq. (6a) can be obtained from the curve fitting, which are listed in FIG. 7(c), with the natural linewidth of the laser being 22.94 Hz, and the maximum linewidth being 21.06 kHz.

FIG. 7(c) shows that, in addition to the plateau with a height about 21.06 kHz, the Δv_{eff}(T_{c}) curve has an intermediate plateau with a height Δv_{mid}

$$Δ {v}_{m i d} = Δ {v}_{max} - ( 1 - k ) * Δ {v}_{span} \qquad ( 8 f )$$

which has a value of 5.65 kHz for the NKT fiber laser. This intermediate plateau is likely due to the frequency locking loop in the laser's control system. Therefore, the double Sigmoid expression of the laser linewidth can be viewed as an indication of a laser frequency control or a RIN reduction loop in the laser system with a time constant relating to the corresponding observation time.

### Effective Linewidth of Desk-Top Lasers Expressed as Double Sigmoid Functions of Observation Time

To further validate the generality of the Sigmoid function presentation of the laser linewidth vs. observation time, we measured two desk-top external cavity tunable semiconductor lasers, which are widely commercially available. The Yenista laser (TUNICS-T100SHP) operates at a fixed wavelength of 1550 nm with a driving current of 198 mA, an output power of 10 dBm and a nominal linewidth of 400 kHz specified by the manufacturer. The Newport laser (TLB-8800-HSH-CL) also operates at a fixed wavelength of 1550 nm in constant current mode with a control current of 200 mA, an output power of 11 dBm. The nominal linewidth is not specified by the manufacturer.

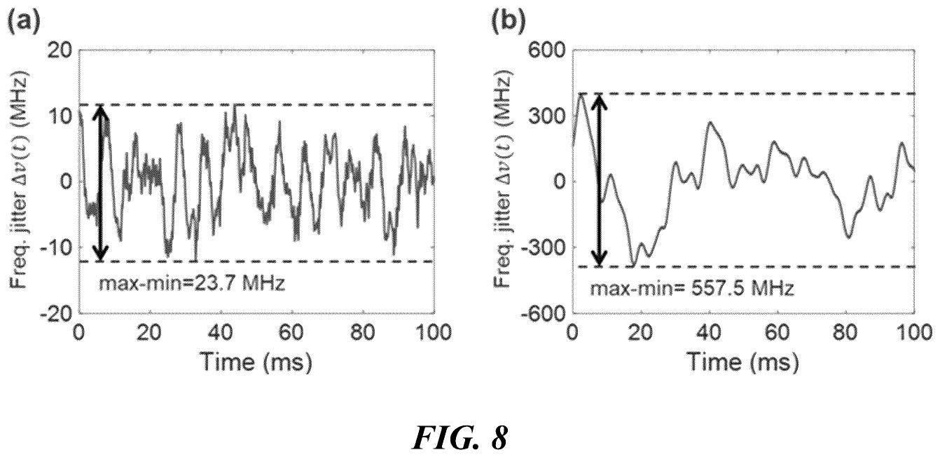

FIG. 8 shows examples of measurements of frequency fluctuations Δv(t) of two desk-top tunable lasers measured with an OPD of 658 m. (a) Yenista laser (Model TUNICS-T100SHP); (b) Newport laser (Model TLB-8800-HSH-CL). More specifically, FIG. 8 shows the frequency fluctuation data Δv(t) of the two lasers measured at a sampling rate of 100 Ms/s with a duration of 0.1 s, with the OPD of 658 m in the interferometer of FIG. 1 (corresponding to a frequency resolution of 7 Hz). It can be seen from FIGS. 8(a) and 8(b) that the Yenista laser has a frequency fluctuation range of 23.7 MHz within 0.1 s, while the Newport laser has a range of 557.5 MHz during same time period.

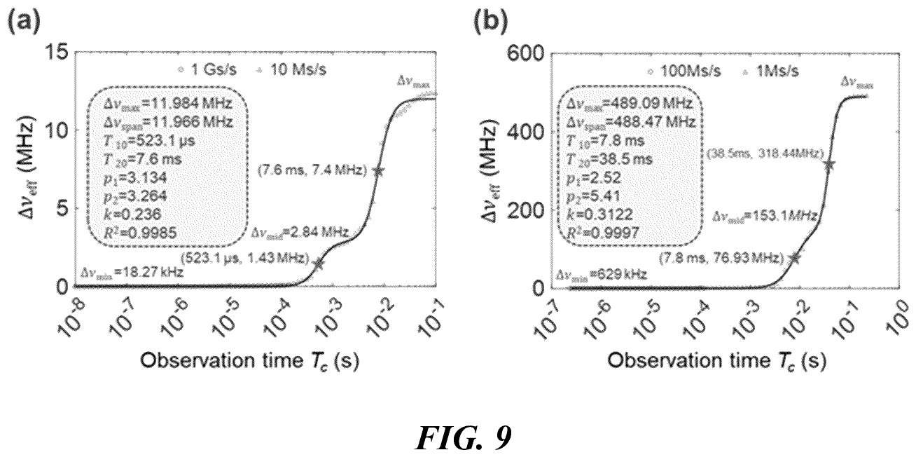

FIG. 9 shows the effective linewidths of the Yenista laser (a) and the Newport laser (b) as a function of observation time (blue circles and brown triangles) obtained with the TDLA procedure described in FIG. 3, with the corresponding curve-fitting to the double Sigmoid functions (black line). In order to have sufficient range of the observation time T_{c}, two sets of Δv(t) data with sampling rates of 10 Ms/s for a duration of 1 s and 1 Gs/s for a duration of 10 ms were collected and combined for the Yenista laser in FIG. 9(a). In processing the data, the cutoff frequencies f_{c} of the high-pass filter were taken from 100 MHz to 10 Hz, corresponding to the observation time T_{c} from 10 ns to 100 ms. The effective linewidth Δv_{eff} corresponding to each observation time T_{c} was then obtained by first calculating the PDF for each observation time T_{c} and getting its 3 dB width (the blue circles and orange triangles). We find that the effective linewidth Δv_{eff} vs. observation time T_{c} data can be perfectly fitted to a double Sigmoid function of Eq. (8a), with a goodness of fit of 0.9985, as anticipated because this laser also has an internal frequency control loop. All the parameters in this double Sigmoid function are listed in FIG. 9(a).

It can be seen from FIG. 9(a) that the minimum and the maximum linewidths are 18.27 kHz and 11.98 MHz, respectively, located in the “lowland” and high “plateau” regions, with the maximum linewidth 656 times the minimum. Similar to FIG. 7(c), there is also an intermediate “plateau” region with a linewidth around 2.84 MHz in the vicinity of T_{c}=1 ms, which may relate to the time constant of the laser's internal frequency control or RIN reduction loop.

The effective linewidth as a function of observation time of the Newport laser is shown in FIG. 9(b). Two sets of data with sampling rates of 1 Ms/s and 100 Ms/s were combined to get sufficient coverage of observation time T_{c} from 100 ns to 100 ms. As expected, the effective linewidth can also be perfectly fitted to a double Sigmoid function of Eq. (8a), with a goodness of fit of 0.9997. As can be seen in FIG. 9(b), the laser has a maximum and minimum effective linewidth of 489 MHz and 629 kHz, respectively, located at the high “plateau” and “lowland” regions, respectively, with the maximum linewidth 777 times larger than the minimum. Although not as obvious as that in FIG. 9(a), there also is an intermediate “plateau” region with a linewidth around 153 MHz, located in the vicinity of 20 ms.

Validation of Results with Accepted Criterion and Method

As discussed previously, Δvₘᵢₙ obtained from the Sigmoid function fit corresponds to the natural linewidth of a laser, which is expected to be inversely proportional to the optical power of the laser according to the STH formula [58].

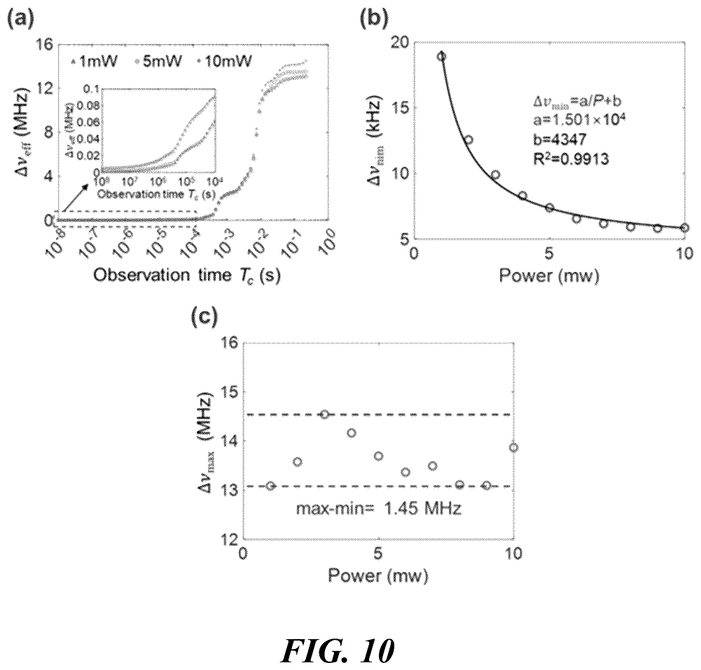

FIG. 10(a) shows the measured Δv_{eff} vs. T_{c} curve of the Yenista laser corresponding to three different laser powers by adjusting the laser driving current measured with an optical path difference (OPD) of 658 m. It can be seen from FIG. 10(a) that both Δvₘᵢₙ and Δvₘₐₓ are dependent on the laser output power.

FIG. 10(b) shows the Δvₘᵢₙ of the Yenista laser at different optical powers determined by fitting the double Sigmoid function of the laser, which indeed has the inverse proportionality with the optical power, with an excellent goodness of fit of 0.9913. Note that the bias term b obtained from curve fitting in the figure is due to the influence of the 1/f noise [17], which is independent of the optical power [58].

On the other hand, the dependency of Δvₘₐₓ on optical power is scattered, as shown by the maximum linewidth Δvₘₐₓ of the laser obtained from the Sigmoid function fit vs. optical power in FIG. 10(c). It is interesting to note from FIG. 10(a) that the effective linewidths at other observation times are almost independent of the optical power.

To further validate our TDLA results and the Sigmoid expression, the commonly used SDLA method is used to obtain Δv_{eff} at different observation times which used the same set of raw data as that of the TDLA taken with the Yenista laser operating at a wavelength of 1550 nm with an output power of 10 mw.

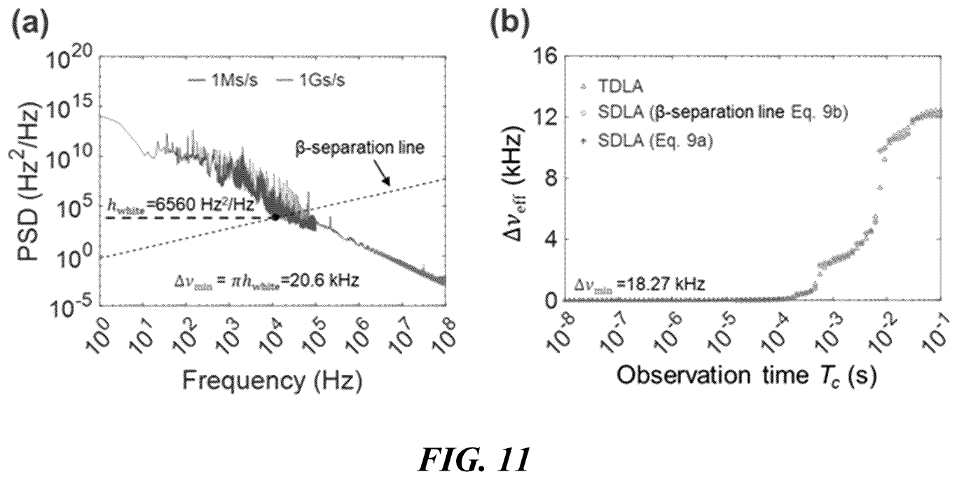

FIG. 11(a) shows the power spectral density (PSD) S_{Δv}(f) of the laser frequency noise, in which two sets of data with different sampling rates were combined and plotted, with the frequency range from 10⁰ to 10⁵ taken with a sampling rate of 1 Ms/s, and from 10⁵ to 10⁸ taken with a sampling rate of 1 Gs/s. The black dashed line is the β-separation line [S_{Δv}(f)=8 ln 2*f/π²], which divides the spectrum into two areas, one contributes to the linewidth and the other defines the amplitude of white noise h_{white} corresponding to the minimum or natural linewidth [25, 43]. The white noise amplitude obtained by the β-separation line is h_{white}=6560 Hz²/Hz, corresponding to the natural linewidth Δvₘᵢₙ=πh_{white}=20.6 kHz.

The effective linewidth of the laser can be calculated with the spectral integration below [25,42,44]:

$$Δ {v}_{eff} ( {T}_{c} ) = 2 \sqrt{2 l n 2} \sqrt{{\int }_{1 / {T}_{c}}^{∞} {S}_{Δ v} ( f ) df} \qquad ( 9 a )$$

$$\approx 2 \sqrt{2 l n 2} \sqrt{{\int }_{1 / {T}_{c}}^{∞} H [ 1 - 8 l n 2 * \frac{f}{{π}^{{}_{2}}} ] {S}_{Δ v} ( f ) df} \qquad ( 9 b )$$

where H(x) is a step function: H(x)=1 if x≥0 and H(x)=0 if x<0.

FIG. 11(b) shows the results of the effective linewidth of the Yenista laser obtained using the SDLA method as a function of T_{c}. It is evident that the SDLA results at different observation time T_{c} are almost identical to those of the TDLA, which can also be perfectly fitted to a logistic function.

Both the SDLA and TDLA methods can be used to obtain laser's effective linewidth for any given observation time with consistent results. However, the SDLA method requires long-term measurements in order to obtain the power spectral density (PSD) of a sufficiently high resolution. In addition, for each observation time, two or more sets of Δv(t) data must be taken with different sampling rates, which must be combined to cover the whole required spectral range, as shown in FIG. 3a. Finally, the PSD obtained with data taken at different times needs to be averaged in order to reduce the measurement uncertainty. On the other hand, the TDLA method is more straightforward and less time consuming. For a given observation time, only one set of Δv(t) data needs to be taken with a single sampling rate, which can be quickly processed to obtain PDF for obtaining the linewidth.

### Applications to Coherent Laser Systems

The techniques disclosed in this patent document enable the linewidths of single-frequency lasers to be represented or expressed as a Sigmoid function of the observation time or a sum of two or more Sigmoid functions of the observation time with a high accuracy for representing the effective laser linewidths. The disclosed sine-cosine optical frequency detection (OFD) system and the time domain statistical linewidth analysis method can be used to evaluate laser linewidths at different observation times, which have been used to confirm the generality of the Sigmoid expression with all seven (7) single-frequency lasers we tested, with laser types ranging from external cavity laser, to grating stabilized diode laser, to fiber laser, and to DFB laser, as shown in Table 1. The disclosed OFD system has a frequency measurement resolution on the order of few hertz and can be improved to subhertz by simply increasing the fiber delay in the OFD system. Conducted natural linewidth measurement results have been validated with the STH formula and the associated Sigmoid expressions with the commonly used SDLA methods.

For example, the laser linewidth expression as a single Sigmoid function of observation time can be understood by considering that two statistical linewidth broadening processes are involved, one is the frequency jitter due to the spontaneous emission noise, which contributes to the natural linewidth at short observation times. The other one is the relatively slow frequency variations caused by the laser cavity fluctuations due to the temperature, vibration, carrier density and/or refractive index fluctuations, which contributes to the linewidth broadening at longer observation times with larger variations.

The laser linewidth expression as a double Sigmoid function of observation time indicates that in addition to the two statistical linewidth broadening processes, a third process may be involved to affect the laser linewidth, such as a feedback loop inside the laser for stabilizing the laser frequency or reducing the RIN, or an additional gain medium inside the laser cavity with a different pump.

TABLE 1
Commercial single-frequency lasers characterized by a single or double Sigmoid
functions

| Manufacturer | Model | Laser Type | Single Sigmoid | Double Sigmoid | |
|---|---|---|---|---|---|
| Pure Photonics | PPCL550 | External cavity | Δvₘₐₓ = 233 kHz | — | |
| | | tunable laser | Δvₘᵢₙ = 6.71 kHz | | |
| | | | T₀ = 8.47 μs | | |
| | | | p = 2.26 | | |
| APEX | AP2051A | Grating | Δvₘₐₓ = 1.34 MHz | — | |
| | | stabilized diode | Δvₘᵢₙ = 104 kHz | | |
| | | laser in | T₀ = 0.218 μs | | |
| | | AP2051A | p = 1.24 | | |
| HAN'S | RP-MR- | DFB laser | Δvₘₐₓ = 61.1 kHz | — | |
| Laser | C34-B080- | module | Δvₘᵢₙ = 1.08 kHz | | |
| | 02-A | | T₀ = 11 μs | | |
| | | | p = 1.074 | | |
| Newport | TLB-8800- | External cavity | — | Δvₘₐₓ = 489.09 MHz | |
| | HSH-CL | tunable laser | | Δvₛₚₐₙ = 488.47 MHz | |
| | | | | Δv_{mid} = 153.1 MHz | |
| | | | | Δvₘᵢₙ = 629 kHz | |
| | | | | k = 0.3122 | |
| | | | | T₁₀ = 7.8 ms | T₂₀ = 38.5 ms |
| | | | | p₁ = 2.52 | p₂ = 5.41 |
| Yenista | TUNICS- | External cavity | — | Δvₘₐₓ = 11.984 MHz | |
| | T100SHP | tunable laser | | Δvₛₚₐₙ = 11.966 MHz | |
| | | | | Δv_{mid} = 2.84 MHz | |
| | | | | Δvₘᵢₙ = 18.27 kHz | |
| | | | | k = 0.236 | |
| | | | | T₁₀ = 523.1 μs | T₂₀ = 7.6 ms |
| | | | | p₁ = 3.134 | p₂ = 3.264 |
| NKT | Koheras | Fiber laser | — | Δvₘₐₓ = 21.06 kHz | |
| | BASIK E15 | | | Δvₛₚₐₙ = 21.04 KHz | |
| | | | | Δv_{mid} = 5.65 KHz | |
| | | | | Δvₘᵢₙ = 22.94 Hz | |
| | | | | k = 0.2675 | |
| | | | | T₁₀ = 103.97 μs | T₂₀ = 8.0 ms |
| | | | | p₁ = 1.676 | p₂ = 1.463 |
| Connet | CoSF-D-Er- | Fiber laser | — | Δvₘₐₓ = 23.19 KHz | |
| | M-1550-PM- | | | Δvₛₚₐₙ = 22.82 KHz | |
| | FA | | | Δv_{mid} =9.48 KHz | |
| | | | | Δvₘᵢₙ = 371 Hz | |
| | | | | k = 0.399 | |
| | | | | T₁₀ = 124.65 μs | T₂₀ = 9.2 ms |
| | | | | p₁ = 1.52 | p₂ = 1.67 |

For some single wavelength CW laser, their effective linewidths may be represented by the sum of more than two Sigmoid functions of observation time. Examples of such single-frequency lasers include single-frequency lasers with additional feedback loops or control mechanisms, including temperature, cavity length, or pump control loops to stabilize the laser frequency, to reduce the frequency draft, or to reduce the frequency fluctuations or noise. The time constants of these control loops may be closely related to the observation times corresponding to the intermediate “plateaus” in the data of the effective linewidth Δv_{eff} vs. observation time T_{c}.

The techniques disclosed herein using Sigmoid expressions of the effective linewidth Δv_{eff} vs. observation time T_{c} can be used to extract key information of the laser linewidths of a single-frequency laser with different measurement durations, and can be used to quickly assess the coherent properties of the laser for optimizing interferometric systems designs, as well as improving the laser performance. The laser linewidth measurements using the disclosed Sigmoid expressions are effective and efficient for a wide range of applications involving optical coherent interferences and single-frequency CW lasers, such as distributed acoustic sensing (DAS) and gravitational wave detections.

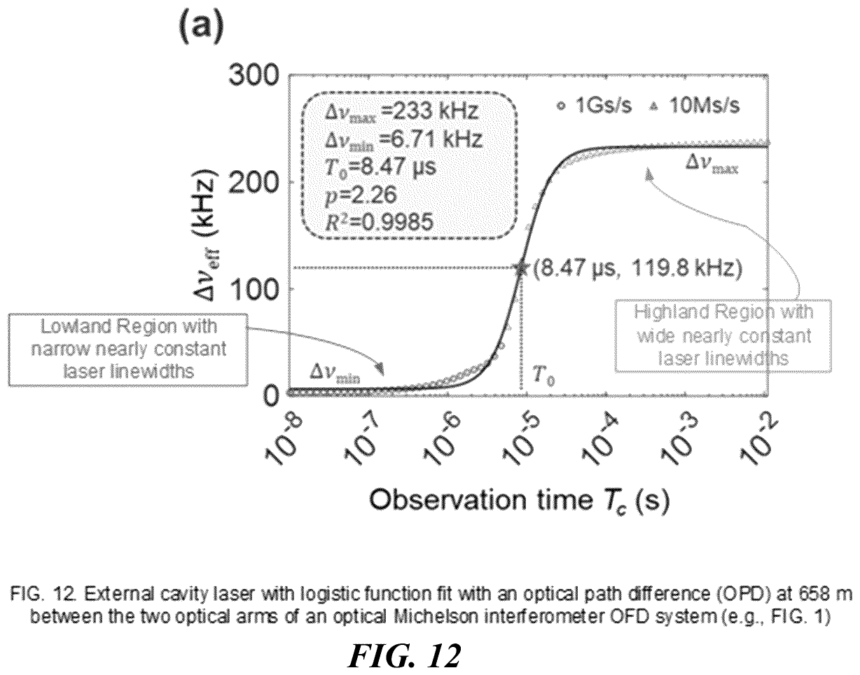

Various components in coherent sensor systems using single-frequency lasers can be designed based on the laser linewidth information contained in an analytic formula that represents laser linewidth characteristics of a single-frequency laser corresponding to different observation times in form of a single Sigmoid function or a sum of two or more Sigmoid functions. As an example, for an interferometric sensor system, the detection bandwidth of the receiving circuit can be designed and optimized with the aid of the Sigmoid expression of the linewidth of the laser used in the system as a function of observation time. In the region of a constant linewidth, such as in the “lowland” region with nearly constant narrow linewidths at lower observation times below T₀ of the linewidth defined by the “S” shaped Sigmoid function (as shown in the above-discussed external cavity laser in FIG. 12), the longer the integration time or the observation time of the circuit (corresponding to narrower receiver bandwidth) is, the better the signal to noise ratio (SNR) of the detection system.

However, as the integration time is increased beyond the “lowland” region into the linewidth ramping region of the Sigmoid curve leading to a “highland” region with wider nearly constant laser linewidths at longer observation times longer than T₀, the SNR may degrade with the increase of the receiver integration time (corresponding to smaller detection bandwidth). Therefore, knowing exactly at what integration time the linewidth starts to increase and the rate of the linewidth increase can help the system designer identify the optimized receiver integration time or bandwidth. A well characterized laser linewidth expressed as the Sigmoid function of the integration or observation time can serve the purpose in a system design. It is advantageous to design the detection circuitry of the interferometric sensor system to strategically place the detection bandwidth in the lowland region of the laser based on the Sigmoid formula of the laser linewidth as a function of the observation time and to set the observation or measurement time accordingly to achieve the narrow laser linewidth and an improved SNR. In implementations, the detection circuitry of the optical interferometer based sensing device can be operated at a maximum integration time not to exceed the observation time at which the laser linewidth starts to rapidly ramp up following the Sigmoid function.

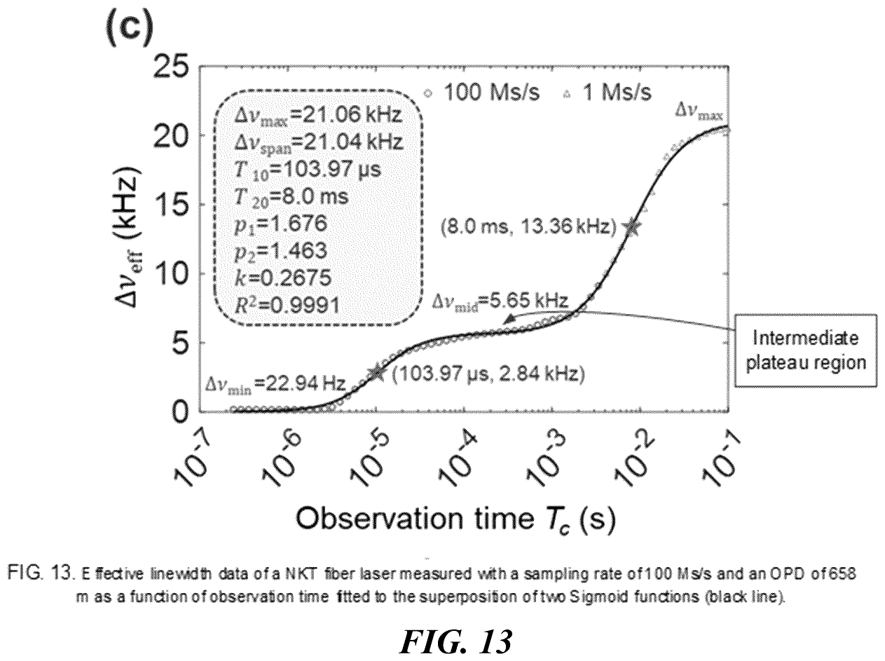

As another example, shown in FIG. 13 for the above-discussed NKT fiber laser, the intermediate “plateau” region of the laser linewidth obeying the double Sigmoid function of the observation time can be used as a compromised region for the receiver integration time or bandwidth in the system design because in this region the laser linewidth is relative insensitive to the receiver detection bandwidth at a relatively low linewidth. Therefore, a well characterized laser linewidth expressed as the double Sigmoid function of observation time can be used to determine this compromised region in designing the instrument.

As a third example, the coherence length of the laser is inversely proportional to its linewidth, which determines the maximum allowable optical path-length difference (OPD) of an interferometric sensor system using the laser. Therefore, the detection bandwidth or integration time actually determines the maximum OPD of the sensor system. With the aid of the Sigmoid expression of the laser linewidth as a function of the observation time, one is able to quickly determine the optimal OPD in the interferometric sensor system.

Accordingly, the disclosed techniques can be implemented to provide a method for designing an optical interferometer based sensing device using coherent laser light from a single-frequency laser such as a LIDAR system. This designing method includes performing measurements on continuous wave laser light at a single laser wavelength from the single-frequency laser to be used in the optical interferometer based sensing device, processing data from the performed measurements to generate an analytical formula that includes one Sigmoid function or a sum of two or more Sigmoid functions to represent a laser spectral linewidth of the single-frequency laser as a function of different observation times, and using the information of the laser linewidth with respect to different observation times from the analytical formula to design detection circuitry of the optical interferometer based sensing device to optimize sensing operations and to reduce sensor noise. In some implementations of this designing method, the detection circuitry of the optical interferometer based sensing device is designed to operate at one or more different observation times within a range within which the linewidth of the laser fluctuates around a constant laser linewidth less than other observation times outside the range.

Supplementary Information: Limitations and Uncertainties of the Exemplary Optical Frequency Detection (OFD) System with TDLA Approach

### I. Frequency Resolution Limited by the Resolution of DAQ Card

From [47], the frequency measurement resolution of the OFD system due to the resolution of the DAQ card is

$$δ {v}_{ADC} = FSR / ( 2 \cdot {2}^{M} ) = 1 / ( {2}^{M + 1} τ ) \qquad ( S1 )$$

where FSR represents the free spectral range of the interferometer, M represents the number of bits of the analog-to-digital converter (ADC) of the DAQ card. In order to accurately measure the laser linewidth, δv_{ADC} must be much finer than the laser linewidth to be measured. For example, if the acquisition card has a resolution of 16 bits, the frequency resolution corresponding to the OPD of 658 m is 7 Hz (assuming an effective resolution of 15 bits), which is much finer than the natural linewidths of the LUTs in our measurements on the order of tens Hz to MHz. Proportionally longer OPD can be used for LUTs with narrower natural linewidths.

### II. The Maximum Detectable Frequency Variation Rate

In addition, the measurement system must be sufficiently fast to capture the fastest laser frequency jitters. As discussed in [47], the speed of the corresponding signal is proportional to the OPD τ. Considering that our DAQ has a maximum sampling rate Rₛ of 1 Gs/s, the maximum frequency variation rate γₘₐₓ can be measured is γₘₐₓ=Rₛ/(2τ) [47]. Corresponding to the OPD of 658 m (τ=2.2 μs), the resulting γₘₐₓ is 228 THz/s. In order to increase γₘₐₓ, one may reduce the OPD t or increase the sampling rate Rₛ. It is advisable to first determine the maximum frequency changing rate of the LUT and then determine the best suitable OPD and Rₛ.

### III. Measurement Uncertainty Due to the System Noise

As discussed in section II, the system noise can contribute to the measurement uncertainty and must be subtracted from the effective linewidth measurement data following the procedure described in FIG. 3. Unfortunately, residual system noise contribution may still present and therefore it is important to find out the linewidth measurement uncertainty even when the system noise equivalent linewidth Δv_{n,V} subtraction procedure is applied.

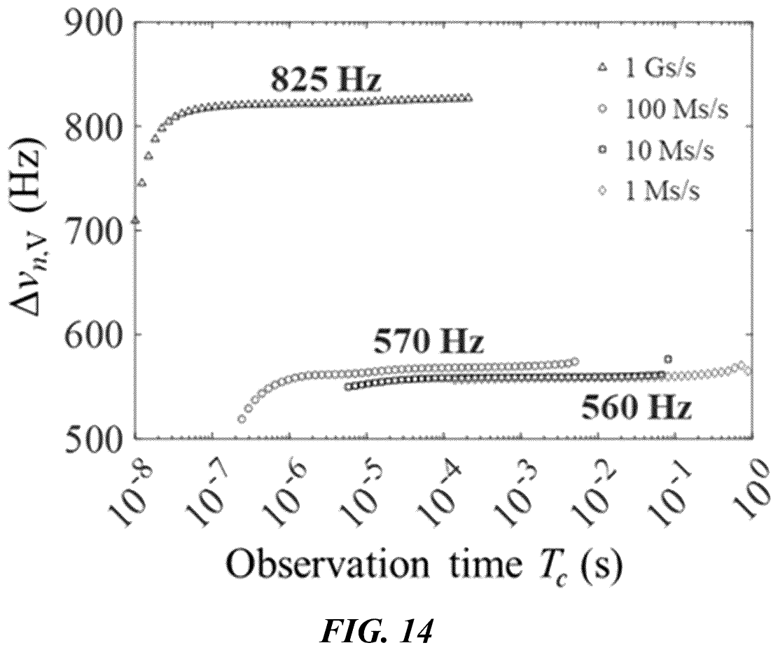

FIG. 14 shows the Δv_{n,V} of the measurement system calculated with V₁ₙ(t), V₂ₙ(t) and V₃ₙ(t) using four different sampling rates of 1 Gs/s, 100 Ms/s, 10 Ms/s, and 1 Ms/s when the LUT is turned off while the OPD is set at 658 m, where V₁ₙ(t), V₂ₙ(t) and V₃ₙ(t) are the voltage outputs from the three photodetectors' amplification circuits and digitized by the DAQ card in FIG. 1 when the LUT is turned off. It can be seen that the Δv_{n,V} corresponding to the 1 Gs/s sampling rate is 825 Hz, much higher than those of other sampling rates. According to [55,56], the relative uncertainty of Δv_{n,V} from curve fitting is between 10⁻² to 10⁻⁵.

If the laser effective linewidth Δv_{eff} at a particular observation time is much larger than Δv_{n,V}, the effect of this Δv_{n,V} on the laser Δv_{eff} is negligible, as the case of FIGS. 5a and 5b. However, if Δv_{n,V} is comparable with Δv_{eff}, the Δv_{n,V} subtraction must be applied. Finally, if Δv_{n,V} is larger than Δv_{eff}, the Δv_{n,V} subtraction may not be sufficient and large measurement uncertainty may result.

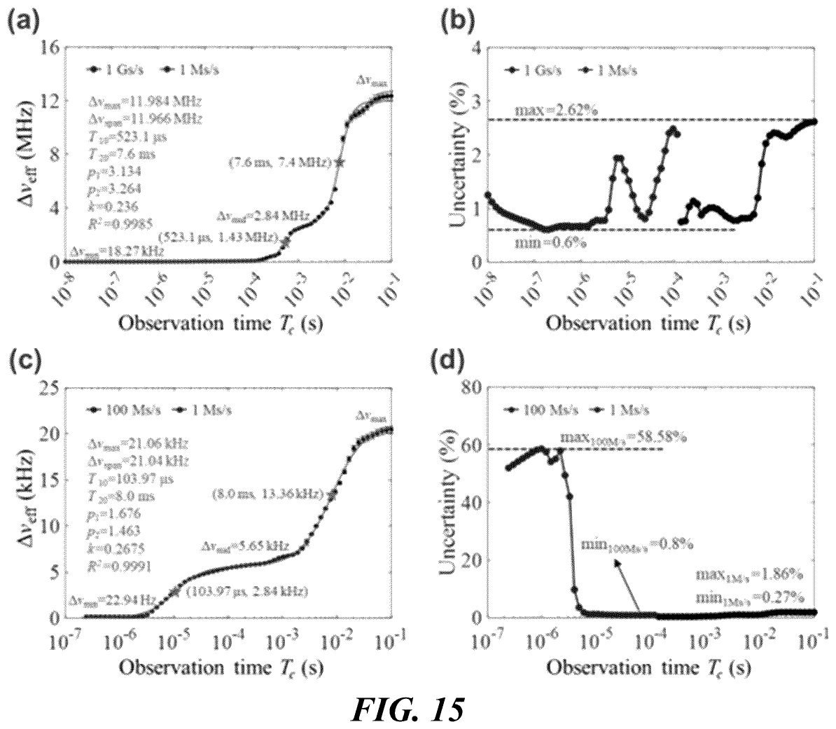

FIG. 15 shows data from 20-time repeatability measurements of the effective linewidth using the OFD of FIG. 1 (OPD=658 m) and the TDLA method: FIG. 15(a) shows the Yenista laser at different observation times obtained by combining two sets of data with sampling rates of 1 Gs/s and 1 Ms/s, with the error bars representing the standard deviation; FIG. 15(b) shows the relative linewidth uncertainty of the Yenista laser derived from the data in FIG. 15(a); FIG. 15(c) shows the effective linewidth and error bars (standard deviation) of the NKT fiber laser at different observation times obtained by combining two sets of data with sampling rates of 100 Ms/s and 1 Ms/s; and FIG. 15(d) The relative linewidth uncertainty derived from FIG. 15(c).

FIG. 15(a) shows the results of 20 repetitive Δv_{eff} measurement of the Yenista laser operating at a fixed wavelength of 1550 nm as a function of observation time T_{c}, with error bars representing the standard deviation. FIG. 15(b) shows the corresponding relative uncertainty of Δv_{eff} at different T_{c}, with the worst relative uncertainty of 2.62%. This small measurement uncertainty is due to the fact that the Δv_{n,V} of the measurement system is much smaller than the laser Δv_{eff} at all observation times T_{c}. In the measurement, the output power of the Yenista laser was set to 10 dBm and the sampling rate of the DAQ was set at 1 Ms/s and 1 Gs/s, as indicated inside FIG. 15(a).

FIG. 15(c) shows the results of 20 repetitive Δv_{eff} measurements of the NKT fiber laser at different observation times T_{c} with the Δv_{n,V} subtraction applied, with error bars representing the standard deviation, while FIG. 15(d) shows the relative linewidth measurement uncertainty derived from FIG. 15(c). It can be seen that a relative linewidth uncertainty for the natural linewidth Δvₘᵢₙ is as large as 58.58%, despite of Δv_{n,V} subtraction because 1) Δv_{n,V} is larger than Δvₘᵢₙ; and 2) the small denominator when computing the relative uncertainty due to the small Δvₘᵢₙ. Nevertheless, the near perfect Sigmoid curve-fit of the linewidth as a function of observation time is not compromised due to the averaging effect of the curve fitting. In the measurement, the output power of the fiber laser was set to 13 dBm, the center wavelength was set at 1550.12 nm, and the sampling rate of the DAQ was set at 100 Ms/s and 1 Ms/s, as indicated inside FIG. 15(c).

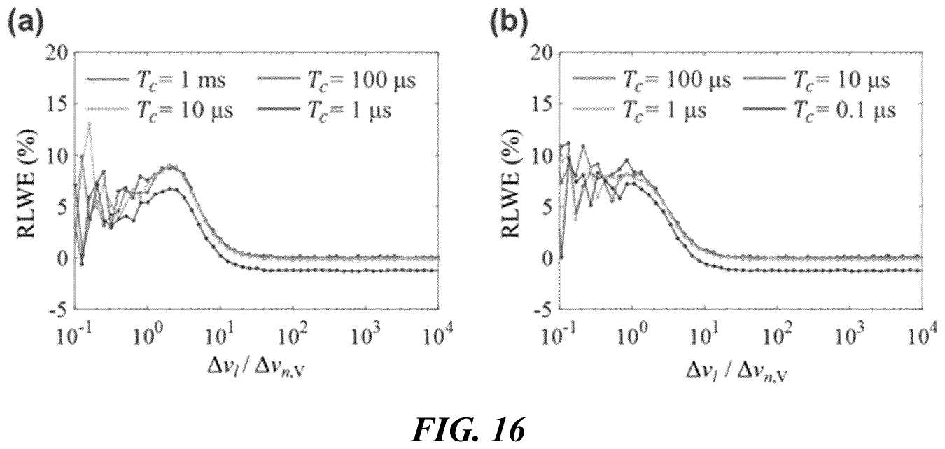

It is therefore important to find out the impact of the Δv_{n,V} on the measurement uncertainty of Δv_{eff}. FIG. 16 shows the numerically simulated relative linewidth measurement error (RLWE) at different laser to noise linewidth ratios, more specifically the ratio of laser's true linewidth Δvₗ over the system noise equivalent linewidth Δv_{n,V} (Δvₗ/Δv_{n,V}). In the simulation process, the system noise in FIG. 1 at a particular sampling rate was first taken, with its PDF calculated as Pₙ(v) and the corresponding system noise equivalent linewidth as Δv_{n,V}. A LUT is assumed to have a frequency noise PDF of Pₗ(v), which is Gaussian white noise with a linewidth of Δvₗ. After adding the system noise to the LUT's frequency noise, the combined linewidth can be obtained as Δv_{l+n,V}. After subtracting the contribution of Δv_{n,V} following the procedure of FIG. 3, the final Voigt linewidth of the laser can be obtained as Δv_{eff}. The RLWE is calculated as

$$RLWE = ( Δ {v}_{eff} - Δ {v}_{l} ) / Δ {v}_{l} \qquad ( S2 )$$

As shown in FIGS. 16(a) and 16(b), when Δvₗ/Δv_{n,V} is greater than 10, the RLWE is stable within ±0.2%. When the SNR is less than 10, the RLWE increases rapidly and gradually approaches to 10%, which is consistent with the uncertainty results of FIGS. 15(b) and 15(d).

### IV. The Range of Observation Time Limited by the Sampling Rate and Time

For statistical analysis, it is necessary for the signal to contain sufficient number of valid sampling points to obtain the PDF of frequency fluctuations for a given observation duration T_{c}. The sampling rate Rₛ, sampling time ΔTₛ, and the total number of sampling points Mₛ are related by:

$${M}_{s} = {R}_{s} Δ {T}_{s} \qquad ( S3 )$$

In this paper, Mₛ during data acquisition is fixed at 10 million points. Therefore, both the sampling rate and time must be chosen accordingly. For wide linewidth lasers, larger Rₛ is required to capture fast frequency variations, and ΔTₛ must be reduced proportionally. While for narrow linewidth lasers, smaller Rₛ is required, and ΔTₛ should be increased accordingly. We found during data processing that for obtaining linewidths with acceptable uncertainty, the observation time should be in the range of:

$$10 / {R}_{s} \leq {T}_{c} \leq Δ {T}_{s} / 10 \qquad ( S4 )$$

For lasers with a large linewidth span Δvₘₐₓ−Δvₘᵢₙ over the observation time, two sampling rates Rₛ₁ and Rₛ₂ and the corresponding sampling times ΔTₛ₁ and ΔTₛ₂ are generally chosen to cover both ends, with Rₛ₁>Rₛ₂ and ΔTₛ₁<ΔTₛ₂. The corresponding range of observation time is

$$10 / {R}_{s 1} \leq {T}_{c} \leq Δ {T}_{s 2} / 10 \qquad ( S5 )$$

For example, for a sampling rate and time of 1 Gs/s and 0.01 s, the range of T_{c} is 10⁻⁸<T_{c}<10⁻³ s. For a measurement requiring two sampling rates 100 Ms/s and 1 Ms/s, with sampling times 0.1 s and 10 s, respectively, the range of T_{c} is 10⁻⁷<T_{c}<1 s. All the linewidth results as a function of observation time in FIGS. 6, 7, 9, and 10 are compliant with this rule.

### V. Measurement Uncertainty Due to System Temperature Variations

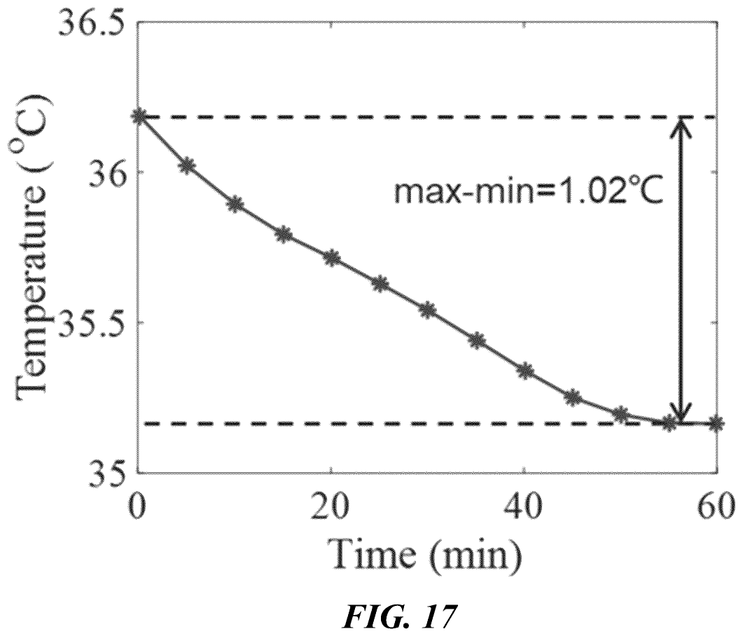

Finally, the temperature variations may affect the OPD of the Michelson interferometer in the OFD system in FIG. 1, causing frequency measurement uncertainties. Therefore, it is important to evaluate its impact on the laser linewidth measurement. FIG. 17 shows the measured temperature inside the thermally insulated enclosure containing the interferometer of the OFD system in FIG. 1. In conducted measurements, the measured temperature varied 1.02° C. over a period of 60 minutes, corresponding to a temperature changing rate approximately 2.8×10⁻⁴° C./s. From Eq. (4), the frequency detection error δv due to the OPD delay variation δτ can be obtained as:

$$δ v / v = - δτ / τ = - {C}_{n} \cdot Δ Temp \qquad ( S6 )$$

where Cₙ is the temperature coefficient of the optical fiber with Cₙ≈0.82×10⁻⁵/° C. [59], and ΔTemp is the temperature variation. For the observation times of 1 μs, 1 ms, and 0.1 s, the corresponding ΔTemp are 2.8×10⁻¹⁰, 2.8×10⁻⁷, and 2.8×10⁻⁵° C., respectively, resulting in δv of 0.45 Hz, 450 Hz, and 45 kHz, which are orders of magnitudes smaller than the laser frequency fluctuations at the corresponding observation times in most cases, except for the NKT fiber laser at T_{c}=0.1 s with comparable magnitudes (see FIG. 7). Therefore, for ultra narrow linewidth lasers, active temperature control of the OPD in the OFD system is required.

In addition to the above specific examples for implementing the disclosed technology, other implementations are also possible.

For example, the disclosed technology may be used to provide a method for designing an optical interferometer based sensing device using coherent laser light from a single-frequency laser which includes performing measurements on continuous wave laser light at a single laser wavelength from the single-frequency laser to be used in the optical interferometer based sensing device; processing data from the performed measurements to generate an analytical formula that includes one Sigmoid function or a sum of two or more Sigmoid functions to represent a laser spectral linewidth of the single-frequency laser as a function of different observation times; and using the information of the laser linewidth with respect to different observation times from the analytical formula to design detection circuitry of the optical interferometer based sensing device to optimize sensing operations and to reduce sensing noise. In one implementation, the above method may further include operating the detection circuitry of the optical interferometer based sensing device to operate at one or more different integration times within a range within which the linewidth of the laser fluctuates around a constant laser linewidth less than other observation times outside the range. In another implementations, the above method may further include operating the detection circuitry of the optical interferometer based sensing device to operate at a maximum integration time not to exceed the observation time at which the laser linewidth starts to rapidly ramp up following the Sigmoid function.

For another example, the disclosed technology may be implemented to provide a method for obtaining information on a laser linewidth of a single-frequency laser which includes processing measurements of frequency fluctuations of a laser frequency of a single-frequency laser performed by both turning on the single-frequency laser and turning off the single-frequency laser to extract data of the measured frequency fluctuations of the laser frequency over different observation times in time domain; processing the extracted data of the measured frequency fluctuations of the laser frequency over different observation times in time domain to compute probability density functions of the measured frequency fluctuations of the laser frequency after subtracting a system noise contribution to the measurements of frequency fluctuations from extracted data based on measurements of frequency fluctuations when turning off the single-frequency laser; and fitting an analytical formula that includes one or more Sigmoid functions to the computed probability density functions of the measured frequency fluctuations of the laser frequency over different observation times in time domain, without the system noise contribution, to transform the data-fitted analytical formula to represent a relationship between an effective laser linewidth of the single-frequency laser as a function of observation time. In one implementation, the processing the extracted data includes processing shown in FIG. 3. In another implementation, the measurements of frequency fluctuations of the laser frequency of the single-frequency laser are obtained from an optical interferometer device which may be a Michaelson interferometer device involving a 3×3 coupler, or a Mach-Zehnder interferometer device involving a 3×3 coupler, a 2×4 multimode interference coupler, or a 90° hybrid coherent receiver.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document.

### REFERENCES

1. T. Kita, R. Tang, and H. Yamada, “Narrow Spectral Linewidth Silicon Photonic Wavelength Tunable Laser Diode for Digital Coherent Communication System,” IEEE Journal of Selected Topics in Quantum Electronics 22, 23-34 (2016).
2. J. O'Carroll, R. Phelan, B. Kelly, D. Byrne, L. P. Barry, and J. O'Gorman, “Wide temperature range 0<T<85° C. narrow linewidth discrete mode laser diodes for coherent communications applications,” Opt. Express 19, B90-B95 (2011).
3. J. Li, Z. Yu, Z. Du, Y. Ji, and C. Liu, “Standoff Chemical Detection Using Laser Absorption Spectroscopy: A Review,” Remote Sensing 12, 2771 (2020).
4. T. Zhang, G. Zhang, X. Liu, G. Gao, and T. Cai, “Measurement of Ethylene Concentrations at High Pressure Based on Tunable Diode Laser Absorption Spectroscopy near 1620 nm,” Journal of Applied Spectroscopy 87, 674-679 (2020).
5. Y. Wu, L. Deng, K. Yang, and W. Liang, “Narrow Linewidth External Cavity Laser Capable of High Repetition Frequency Tuning for FMCW LiDAR,” IEEE Photonics Technology Letters 34, 1123-1126 (2022).
6. G. Jihong, C. Spiegelberg, and J. Shibin, “Narrow linewidth fiber laser for 100-km optical frequency domain reflectometry,” IEEE Photonics Technology Letters 17, 1827-1829 (2005).
7. L. Ming, Q. Haifeng, S. Zhihui, W. Weitao, S. Zhiqiang, G. Jian, and Z. Xucheng, “Development of narrow linewidth distribution feedback fiber laser for fiber hydrophone system,” in Proc. SPIE, 1203002 (2021).
8. Y. Li, B. Lu, L. Ren, H. Chen, Y. Qiu, B. Mao, P. Zhou, C. Zhao, and X. Dong, “A highly precise FBG sensor interrogation system with wavemeter calibration,” Optical Fiber Technology 48, 207-212 (2019).
9. Y. Y. Jiang, A. D. Ludlow, N. D. Lemke, R. W. Fox, J. A. Sherman, L. S. Ma, and C. W. Oates, “Making optical atomic clocks more stable with 10-16-level laser stabilization,” Nature Photonics 5, 158-161 (2011).
10. A. D. Ludlow, M. M. Boyd, T. Zelevinsky, S. M. Foreman, S. Blatt, M. Notcutt, T. Ido, and J. Ye, “Systematic Study of the ⁸⁷Sr Clock Transition in an Optical Lattice,” Physical Review Letters 96, 033003 (2006).
11. B. P. Abbott et al., “LIGO: the Laser Interferometer Gravitational-Wave Observatory,” Reports on Progress in Physics 72, 076901 (2009).
12. H. Tsuchida, “Characterization of White and Flicker Frequency Modulation Noise in Narrow-Linewidth Laser Diodes,” IEEE Photonics Technology Letters 23, 727-729 (2011).
13. K. Kikuchi, “Effect of 1/f-type FM noise on semiconductor-laser linewidth residual in high-power limit,” IEEE Journal of Quantum Electronics 25, 684-688 (1989).
14. A. L. Schawlow and C. H. Townes, “Infrared and Optical Masers,” Physical Review 112, 1940-1949 (1958).
15. C. Henry, “Theory of the linewidth of semiconductor lasers,” IEEE Journal of Quantum Electronics 18, 259-264 (1982).
16. K. Kikuchi and T. Okoshi, “Dependence of semiconductor laser linewidth on measurement time: evidence of predominance of 1/f noise,” Electronics Letters 21, 1011-1012 (1985).
17. L. B. Mercer, “1/f frequency noise effects on self-heterodyne linewidth measurements,” Journal of Lightwave Technology 9, 485-493 (1991).
18. R. Zhang, K. Kuzmin, W.-J. Jiang, G. Giaretta, T. Tomimoto, Y. Weng, G.-K. Chang, and W. Way, “Impact of laser flicker noise and linewidth on 64 to 96 Gbaud/DP-nQAM metro coherent optical links,” Optics Letters 45, 1220-1223 (2020).
19. L. Kazovsky, “Performance analysis and laser linewidth requirements for optical PSK heterodyne communications systems,” Journal of Lightwave Technology 4, 415-425 (1986).
20. L. Kazovsky, “Balanced phase-locked loops for optical homodyne receivers: performance analysis, design considerations, and laser linewidth requirements,” Journal of Lightwave Technology 4, 182-195 (1986).
21. K. Kikuchi, “Impact of 1/f-type FM noise on coherent optical communications,” Electronics Letters 17, 885-887 (1987).
22. M. Harris, G. N. Pearson, J. M. Vaughan, D. Letalick, and C. Karlsson, “The role of laser coherence length in continuous-wave coherent laser radar,” Journal of Modern Optics 45, 1567-1581 (1998).
23. M.-C. Amann, “Phase noise limited resolution of coherent LIDAR using widely tunable laser diodes,” Electronics Letters 28, 1694-1696 (1992).
24. S. Leilei, Z. Tao, H. Qian, and H. Shihong, “Effect of laser linewidth on phase-OTDR based distributed vibration sensing regime,” in Proc. SPIE, 91576H (SPIE, Santander, 2014).
25. G. Di Domenico, S. Schilt, and P. Thomann, “Simple approach to the relation between laser frequency noise and laser line shape,” Applied optics 49, 4801-4807 (2010).
26. M. Pollnau and M. Eichhorn, “Spectral coherence, Part I: Passive-resonator linewidth, fundamental laser linewidth, and Schawlow-Townes approximation,” Progress in Quantum Electronics 72, 100255 (2020).
27. Z. Bai, Z. Zhao, Y. Qi, J. Ding, S. Li, X. Yan, Y. Wang, and Z. Lu, “Narrow-linewidth laser linewidth measurement technology,” Frontiers in Physics, 684 (2021).
28. B. Young, F. Cruz, W. Itano, and J. Bergquist, “Visible lasers with subhertz linewidths,” Physical Review Letters 82, 3799 (1999).
29. T. Kessler, C. Hagemann, C. Grebing, T. Legero, U. Sterr, F. Riehle, M. J. Martin, L. Chen, and J. Ye, “A sub-40-mHz-linewidth laser based on a silicon single-crystal optical cavity,” Nature Photonics 6, 687-692 (2012).
30. W. Liang, V. S. Ilchenko, D. Eliyahu, A. A. Savchenkov, A. B. Matsko, D. Seidel, and L. Maleki, “Ultralow noise miniature external cavity semiconductor laser,” Nature Communications 6, 7371 (2015).
31. N. G. Pavlov, S. Koptyaev, G. V. Lihachev, A. S. Voloshin, A. S. Gorodnitskiy, M. V. Ryabko, S. V. Polonsky, and M. L. Gorodetsky, “Narrow-linewidth lasing and soliton Kerr microcombs with ordinary laser diodes,” Nature Photonics 12, 694-698 (2018).
32. A. Kueng, L. Thevenaz, and P. A. Robert, “Laser linewidth determination in the sub-Megahertz range using a Brillouin fibre laser,” in Proceedings of European Conference on Optical Communication, 305-308 vol. 302 (1996).
33. M. Nazarathy, W. V. Sorin, D. M. Baney, and S. A. Newton, “Spectral analysis of optical mixing measurements,” Journal of Lightwave Technology 7, 1083-1096 (1989).
34. T. Okoshi, K. Kikuchi, and A. Nakayama, “Novel method for high resolution measurement of laser output spectrum,” Electronics letters 16, 630-631 (1980).
35. Y. Peng, “A novel scheme for hundred-hertz linewidth measurements with the self-heterodyne method,” Chinese Physics Letters 30, 084208 (2013).
36. J. W. Dawson, N. Park, and K. J. Vahala, “An improved delayed self-heterodyne interferometer for linewidth measurements,” IEEE Photonics Technology Letters 4, 1063-1066 (1992).
37. J. Gao, D. Jiao, X. Deng, J. Liu, L. Zhang, Q. Zang, X. Zhang, T. Liu, and S. Zhang, “A Polarization-Insensitive Recirculating Delayed Self-Heterodyne Method for Sub-Kilohertz Laser Linewidth Measurement,” Photonics 8, 137 (2021).
38. S. Huang, T. Zhu, Z. Cao, M. Liu, M. Deng, J. Liu, and X. Li, “Laser Linewidth Measurement Based on Amplitude Difference Comparison of Coherent Envelope,” IEEE Photonics Technology Letters 28, 759-762 (2016).
39. Z. Wang, C. Ke, Y. Zhong, C. Xing, H. Wang, K. Yang, S. Cui, and D. Liu, “Ultra-narrow-linewidth measurement utilizing dual-parameter acquisition through a partially coherent light interference,” Opt. Express 28, 8484-8493 (2020).
40. A. Canagasabey, A. Michie, J. Canning, J. Holdsworth, S. Fleming, H.-C. Wang, and M. L. Åslund, “A Comparison of Delayed Self-Heterodyne Interference Measurement of Laser Linewidth Using Mach-Zehnder and Michelson Interferometers,” Sensors 11, 9233-9241 (2011).
41. M. Chen, Z. Meng, J. Wang, and W. Chen, “Ultra-narrow linewidth measurement based on Voigt profile fitting,” Opt. Express 23, 6803-6808 (2015).
42. N. Bucalovic, V. Dolgovskiy, C. Schori, P. Thomann, G. Di Domenico, and S. Schilt, “Experimental validation of a simple approximation to determine the linewidth of a laser from its frequency noise spectrum,” Applied Optics 51, 4582-4588 (2012).
43. D. Xu, F. Yang, D. Chen, F. Wei, H. Cai, Z. Fang, and R. Qu, “Laser phase and frequency noise measurement by Michelson interferometer composed of a 3×3 optical fiber coupler,” Opt. Express 23, 22386-22393 (2015).
44. Q. Zhou, J. Qin, W. Xie, Z. Liu, Y. Tong, Y. Dong, and W. Hu, “Power-area method to precisely estimate laser linewidth from its frequency-noise spectrum,” Applied Optics 54, 8282-8289 (2015).
45. X. S. Yao and X. J. Chen, “Sine-cosine optical frequency encoder devices based on optical polarization properties,” U.S. Pat. No. 10,895,477 (2021).
46. X. S. Yao, X. Ma, and T. Feng, “Fast optical frequency detection techniques for coherent distributed sensing and communication systems,” in 2022 Optical Fiber Communications Conference and Exhibition (OFC), 1-3 (IEEE, San Diego, 2022).
47. X. S. Yao and X. Ma, “Sine-Cosine Techniques for Detecting Fast Optical Frequency Variations With Ultra-High Resolution,” Journal of Lightwave Technology 41, 1041-1053 (2023).
48. X. S. Yao, “Sine-cosine optical frequency detection devices for photonics integrated circuits and applications in lidar and other distributed optical sensing,” U.S. Pat. No. 11,619,783 B2 (2023).
49. A. Apicella, F. Donnarumma, F. Isgrò, and R. Prevete, “A survey on modern trainable activation functions,” Neural Networks 138, 14-32 (2021).
50. M. Goyal, R. Goyal, P. Venkatappa Reddy, and B. Lall, “Activation functions,” Deep learning: Algorithms and applications, 1-30 (2020).
51. X. S. Yao and X. Chen, “Polarization Management Components and Devices,” in Polarization Measurement and Control in Optical Fiber Communication and Sensor Systems (IEEE, 2023), pp. 177-240.
52. L. S. Yan, L. Lin, A. Belisle, S. Wey, and X. S. Yao, “Programmable optical delay generator with uniform output and double-delay capability,” J. Opt. Netw. 6, 13-18 (2007).
53. Y. Liu, B. Qi, and D. E. Winder, “Faraday Michelson Interferometers for Signal Demodulation of Fiber-Optic Sensors,” Journal of Lightwave Technology 39, 2552-2558 (2021).
54. R. G. Priest, “Analysis of Fiber Interferometer Utilizing 3×3 Fiber Coupler,” IEEE Transactions on Microwave Theory and Techniques 30, 1589-1591 (1982).
55. Y. Fu, Q. Wu, Y. Yao, Y. Gan, C. Liu, Y. Yang, J. Tian, and K. Xu, “Rapid and precise phase retrieval from two-frame tilt-shift based on Lissajous ellipse fitting and ellipse standardization,” Opt. Express 28, 3952-3964 (2020).
56. M. Ruzi, “voigt line shape fit” (2023), retrieved Aug. 18, 2023, https://www.mathworks.com/matlabcentral/fileexchange/57603-voigt-line-shape-fit.
57. D. H. Johnson, “Statistical signal processing.” retrieved Aug. 18, 2023, https://elec531.rice.edu/files/2022/03/notes.pdf
58. C. Henry, “Phase noise in semiconductor lasers,” Journal of Lightwave Technology 4, 298-311 (1986).
59. X. Wang and X. S. Yao. “Phase-Locked Opto-Electronic Oscillator (OEO) of Ultralow Phase Noise With Record-Low Allan Deviation of 3.4×10\hat{ }(−14) at 1 s.” IEEE Transactions on Microwave Theory and Techniques. 1-12 (2023).

What is claimed is what is described and/or illustrated, including:

1. A method for characterizing a laser linewidth of a single-frequency laser in time domain, comprising:
measuring frequency fluctuations of the single-frequency laser over time;
filtering data of the measured frequency fluctuations by using a high pass filter with a cutoff frequency of f_{c} which is related to an observation time T_{c} in measuring the frequency fluctuations of the single-frequency laser by T_{c}=1/f_{c};
obtaining a probability density function (PDF) from the measured frequency fluctuation data;
taking a full width half maximum (FWHM) width of the PDF as the linewidth of the single-frequency laser at the observation time T_{c};
changing a value of the cutoff frequency of the high pass filter to different cutoff frequency values to obtain different FWHM values of the PDF corresponding to different observation times; and
curve-fitting the FWHM values of the PDF at the different observation times to a single Sigmoid function or a sum of two or more Sigmoid functions to obtain an analytic formula that represents laser linewidth characteristics of the single-frequency laser corresponding to different observation times.

2. The method as in claim 1, wherein the measuring of the frequency fluctuations of the single-frequency laser is performed by using a sine-cosine optical frequency detection system.

3. The method as in claim 2, wherein the sine-cosine optical frequency detection system includes an unbalanced optical interferometer involving a 3×3 coupler, a 2×4 multimode interference coupler, or a 90° hybrid coherent receiver.

4. The method as in claim 1, further comprising a step to subtract noise of a measurement system for measuring the frequency fluctuations of the single-frequency laser by measuring the noise of the measurement system after turning off the single-frequency laser, high-pass filtering the data with different cutoff frequencies, obtaining the equivalent linewidths of the system noise at different observation times corresponding to the different cutoff frequencies, and finally subtracting each equivalent system noise linewidth from the corresponding laser linewidth obtained in claim 1 at each observation time, as described in FIG. 3.

5. A method for characterizing a laser linewidth of a single-frequency laser in time domain, comprising:
measuring frequency fluctuations of the single-frequency laser;
taking the fast Fourier transform of the measured frequency fluctuations in form of frequency fluctuation data;
calculating a power spectral density (PSD) from the fast Fourier transform of the frequency fluctuation data;
computing the integral of the PSD in a frequency range starting from a lower frequency to a sufficiently high frequency, wherein the lower frequency is one over an observation time;
obtaining different integrals of the PSD with different lower frequencies corresponding to different observation times;
obtaining the linewidths at the different observation times from the integrals corresponding to different observation times;
curve-fitting the linewidths of the lasers at different observation times to a single Sigmoid function or a sum of two or more Sigmoid functions to obtain an analytic formula that represents linewidth characteristics of the single-frequency laser corresponding to different observation times.

6. The method as in claim 5, wherein the measuring of the frequency fluctuations of the single-frequency laser is performed by using a sine-cosine optical frequency detection system.

7. The method as in claim 6, wherein the sine-cosine optical frequency detection system includes an unbalanced optical interferometer constructed with a 3×3 coupler, a 2×4 multimode interference coupler, or a 90° hybrid coherent receiver.

8. The method as in claim 5, wherein the integral of the PSD is approximated by using a β-separation line described in FIG. 2.

9. A method for characterizing a laser linewidth of a single-frequency laser, comprising:
processing measurements of frequency fluctuations of a laser frequency of a single-frequency laser performed by both turning on the single-frequency laser and turning off the single-frequency to extract data of the measured frequency fluctuations of the laser frequency over different observation times in time domain and to obtain a system noise contribution to the measurements of frequency fluctuations based on measurements of frequency fluctuations when turning off the single-frequency laser; and
processing the extracted data of the measured frequency fluctuations of the laser frequency over different observation times in time domain, after subtracting the obtained system noise contribution, to generate an analytical formula that includes one or more Sigmoid functions and represents a relationship between an effective laser linewidth of the single-frequency laser as a function of observation time.

10. The method as in claim 9, wherein the processing of the extracted data includes processing shown in FIG. 3.

11. The method as in claim 9, wherein the measurements of frequency fluctuations of the laser frequency of the single-frequency laser are measurements from an optical interferometer device.

12. The method as in claim 11, wherein the optical interferometer device is an unbalanced Michaelson interferometer device.

13. The method as in claim 11, wherein the optical interferometer device is an unbalanced Michaelson interferometer device as shown in FIG. 1.

14. A method for operating a single-frequency laser, comprising:
operating the single-frequency laser to produce output laser light to a target based on information of a laser spectral linewidth of the laser light using the analytical formula that includes one or more Sigmoid functions of claim 9.

15. A method for operating a single-frequency laser, comprising:
adjusting one or more control parameters of a control module inside the single-frequency laser to alter the spectral behavior of the single-frequency laser with respect to an observation time based on the linewidth information of the laser light characterized by the analytical formula that includes one or more Sigmoid functions of claim 9.

16. The method of claim 15, wherein the control module includes a frequency control feedback loop coupled to the single-frequency laser to control the laser frequency.

17. The method of claim 15, wherein the control module includes a relative intensity noise reduction loop coupled to the single-frequency laser to reduce relative intensity noise.

18. The method of claim 15, wherein the control module includes a laser cavity stabilization loop coupled to the single-frequency laser to stabilize a cavity of the single-frequency laser.

19. The method of claim 15, wherein the control module includes a laser pump control loop coupled to the single-frequency laser to control energy that is used to pump the single-frequency laser.

20. The method of claim 15, wherein the control module includes a delay control feedback loop coupled to the single-frequency laser to a delay time of the delay control loop.
